(19) United States
(12) Patent Application Publication
(10) Pub. No.: US 2022/0010037 A1
(43) Pub. Date: Jan. 13, 2022

(54) METHOD FOR PRODUCING RESIN COMPOSITION, AND RESIN COMPOSITION

(71) Applicant: KANEKA CORPORATION, Osaka (JP)

(72) Inventor: Yu Nagaoka, Hyogo (JP)

(73) Assignee: KANEKA CORPORATION, Osaka (JP)

(21) Appl. No.: 17/486,166

(22) Filed: Sep. 27, 2021

Related U.S. Application Data
(63) Continuation of application No. PCT/JP2020/014658, filed on Mar. 30, 2020.

(30) Foreign Application Priority Data
Mar. 28, 2019 (JP) 2019-063423

(51) Int. Cl. C08C 1/14; C08L 51/04

(52) U.S. Cl. CPC C08C 1/14; C08L 51/04

(57) ABSTRACT

A resin composition is produced by a method including a step of rapidly freezing a latex containing fine polymer particles (A), a step of thawing the latex which has been frozen in the preceding step, a step of mixing, into the latex which has been subjected to the preceding step, a resin (B) having a specific viscosity, and after the preceding steps, a step of separating the latex into a resin composition and a water component. The resin composition is an agglutinate containing the fine polymer particles (A) and the resin (B).

### TECHNICAL FIELD

One or more embodiments of the present invention relate to (i) a method of producing a resin composition and (ii) a resin composition.

### BACKGROUND

Thermosetting resins have various kinds of excellent properties such as high heat resistance and high mechanical strength, and therefore are used in various fields. Out of the thermosetting resins, epoxy resins are used in a wide variety of applications, as matrix resins for, for example, sealants for electronic circuits, paints, adhesive agents, and fiber-reinforced materials. The epoxy resins have excellent heat resistance, chemical resistance, insulating properties, and the like, but are insufficient in impact resistance which is a characteristic of thermosetting resins. One widely used method to improve the impact resistance of a thermosetting resin is to add an elastomer to the thermosetting resin.

Examples of the elastomer encompass fine polymer particles (for example, fine crosslinked polymer particles). It is easy to simply mix the fine polymer particles and the thermosetting resin (for example, epoxy resin). The fine polymer particles and the thermosetting resin are mixed, for example, in the following manner. Several fine polymer particles each of which has a particle size of less than 1 μm are collected to prepare a powdery and/or granular material of the fine polymer particles which has a particle size of not less than 1 μm. Thereafter, the powdery and/or granular material and the thermosetting resin are mechanically mixed. Note that a powdery and/or granular material of fine polymer particles, which is prepared by collecting several fine polymer particles in this manner, is also referred to as secondary particles. Note also that fine polymer particles themselves, which have not been processed into a powdery and/or granular material and each of which has a particle size of less than 1 μm, are also referred to as primary particles. By the above mixing method, it is possible to disperse secondary particles of the fine polymer particles in the thermosetting resin. However, it is extremely difficult, at an industrial level, to disperse, in the thermosetting resin, primary particles of the fine polymer particles, each of which has a particle size of less than 1 μm.

In a case where the secondary particles (powdery and/or granular material) of the fine polymer particles and the thermosetting resin are mechanically mixed as described above to obtain a resin composition, the primary particles of the fine polymer particles remain agglutinating in the resin composition. Therefore, the surface appearance of a cured product obtained by curing the obtained resin composition is extremely poor. Therefore, various production methods have been proposed in each of which the fine polymer particles are dispersed in the form of the primary particles in the thermosetting resin.

Patent Literature 1 discloses a production method in which rubbery polymer particles (A) (fine polymer particles) are dispersed in a polymerizable organic compound (H) (thermosetting resin) with use of a solvent.

Patent Literature 2 discloses a production method in which a crosslinked rubbery copolymer (fine polymer particles) is dispersed in a compound (thermosetting resin) containing an epoxy group, with use of a dehydrated resin but without use of a solvent.

### PATENT LITERATURE

[Patent Literature 1]

PCT International Publication No. WO 2005/028546

[Patent Literature 2]

Japanese Patent Application Publication, Tokukaihei, No. 5-339471 (1997)

However, conventional techniques as described above are not sufficient from the viewpoint of an environmental load or the dispersibility of fine polymer particles in a resin composition, and therefore have room for further improvement. In addition, in a case where a solvent is used or salting out is carried out with use of a mineral salt or the like when fine polymer particles are collected from a latex, there are an environmental load, inclusion of impurities, and the like.

### SUMMARY

One or more embodiments of the present invention have been made in view of the above to provide a novel resin composition which imposes a reduced environmental load, contains few impurities, and is excellent in dispersibility of fine polymer particles.

As a result of conducting diligent studies in order to attain the above, the inventors of one or more embodiments of the present invention newly found that it is possible to weaken an emulsifying effect by, when collecting fine polymer particles from a latex containing the fine polymer particles, carrying out (i) a step of freezing the latex and/or (ii) a step of shearing the latex, and accordingly possible to collect the fine polymer particles without use of a flocculant such as a solvent or a mineral salt. Furthermore, the inventors of one or more embodiments of the present invention uniquely found that a resin composition containing the fine polymer particles obtained by such a method exhibits favorable dispersibility when mixed with a matrix resin. Consequently, the inventors of one or more embodiments of the present invention completed one or more embodiments of the present invention.

Specifically, one or more embodiments of the present invention include the following.

A method of producing a resin composition, including: a rapid freezing step of rapidly freezing a latex containing fine polymer particles (A); a thawing step of thawing the latex which has been frozen in the rapid freezing step; a resin mixing step of mixing, into the latex which has been subjected to the rapid freezing step, a resin (B) which is, at 25° C., a liquid having a viscosity of 100 mPa·s to 1,000,000 mPa·s, a semisolid, or a solid; and after the thawing step and the resin mixing step, a separating step of separating the latex into a resin composition and a water component, the resin composition being an agglutinate containing the fine polymer particles (A) and the resin (B).

A method of producing a resin composition, including: a resin mixing step of mixing, into a latex containing fine polymer particles (A), a resin (B) which is, at 25° C., a liquid having a viscosity of 100 mPa·s to 1,000,000 mPa·s, a semisolid, or a solid; a freezing step of freezing the latex which has been obtained in the resin mixing step and in which the resin (B) is dispersed; a thawing step of thawing the latex which has been frozen in the freezing step; and after the thawing step, a separating step of separating the latex into a resin composition and a water component, the resin composition being an agglutinate containing the fine polymer particles (A) and the resin (B).

A method of producing a resin composition, including: a resin mixing step of mixing, into a latex containing fine polymer particles (A), a resin (B) which is, at 25° C., a liquid having a viscosity of 100 mPa·s to 1,000,000 mPa·s, a semisolid, or a solid; a shearing step of applying shearing stress to the latex which has been obtained in the resin mixing step; and after the shearing step, a first separating step of separating the latex into a resin composition and a water component, the resin composition being an agglutinate containing the fine polymer particles (A) and the resin (B).

A resin composition containing: fine polymer particles (A) which have a graft part that is constituted by a polymer containing, as one or more structural units, one or more structural units derived from at least one type of monomer selected from the group consisting of aromatic vinyl monomers, vinyl cyanide monomers, and (meth)acrylate monomers; and a resin (B) which is, at 25° C., a liquid having a viscosity of 100 mPa·s to 1,000,000 mPa·s, a semisolid, or a solid, in a case where a total amount of the fine polymer particles (A) and the resin (B) is regarded as 100% by weight, an amount of the fine polymer particles (A) being 1% by weight to 70% by weight and an amount of the resin (B) being 30% by weight to 99% by weight, in a case where an amount of the fine polymer particles (A) contained in the resin (B) is 5% by weight, dispersibility of the fine polymer particles (A) in the resin (B) being not more than 0 μm when evaluated in accordance with JIS K5101 with use of a grind gauge, the resin composition substantially not containing an organic solvent, the resin composition containing sulfur (S) and phosphorus (P) each in an amount of not more than 150 ppm, the resin composition having an electric conductivity of not more than 0.6 mS/cm.

According to one or more embodiments of the present invention, it is possible to provide a resin composition which imposes a reduced environmental load, contains few impurities, and is excellent in dispersibility of fine polymer particles.

### DETAILED DESCRIPTION

The following description will discuss one or more embodiments of the present invention. Embodiments of the present invention are not, however, limited to these embodiments. One or more embodiments of the present invention are not limited to the configurations described below, but may be altered in various ways within the scope of the claims. One or more embodiments of the present invention also encompass, in their technical scope, any embodiments or examples derived by combining technical means disclosed in differing embodiments and Examples. Further, it is possible to form a new technical feature by combining the technical means disclosed in various embodiments. All academic and patent documents cited in the present specification are incorporated herein by reference. Any numerical range expressed as “A to B” in the present specification means “not less than A and not more than B (i.e., a range from A to B which includes both A and B)” unless otherwise stated.

[1. Method of Producing Resin Composition (Embodiment 1 Involving a Freezing Step)]

A method of producing a resin composition in accordance with one or more embodiments of the present invention includes: a rapid freezing step of rapidly freezing a latex containing fine polymer particles (A); a thawing step of thawing the latex which has been frozen in the rapid freezing step; a resin mixing step of mixing, into the latex which has been subjected to the rapid freezing step, a resin (B) having a viscosity of not more than 1,000,000 mPa·s at 25° C.; and after the thawing step and the resin mixing step, a separating step of separating the latex into a resin composition and a water component, the resin composition being an agglutinate containing the fine polymer particles (A) and the resin (B). Hereinafter, the method of producing a resin composition in accordance with one or more embodiments of the present invention may be simply referred to as a present production method.

The inventors of one or more embodiments of the present invention found that rapid freezing of the latex containing the fine polymer particles (A) causes water to freeze faster than the fine polymer particles (A) agglutinate and thereby allows obtainment of a loose agglutinate in which the fine polymer particles (A) loosely agglutinate. By (i) adding the resin (B) to the loose agglutinate in which the fine polymer particles (A) loosely agglutinate and (ii) mixing them, the agglutinate in which the fine polymer particles (A) are uniformly dispersed in the resin (B) is obtained. In contrast, slow freezing of the latex containing the fine polymer particles (A) causes the fine polymer particles (A) to firmly agglutinate. Even in a case where such an agglutinate is then mixed with the resin (B), it is difficult to obtain the agglutinate in which the fine polymer particles (A) are uniformly dispersed in the resin (B). Thus, the slow freezing of the latex containing the fine polymer particles (A) is not preferable. In other words, according to the present production method, it can be said that a fast freezing rate is important.

According to the present production method, since a salt such as a flocculant is not used, it is possible to obtain the agglutinate which contains few contaminants (few impurities). Moreover, since an organic solvent is not used, an environmental load is reduced. In addition, by carrying out the freezing step, it is possible to efficiently separate the agglutinate of the fine polymer particles (A) etc. and the water component, and therefore possible to collect the fine polymer particles (A) at a high yield. Furthermore, it is possible to reduce inclusion of an emulsifying agent in the agglutinate, and therefore possible to obtain the agglutinate which contains few emulsifying agent-derived substances (impurities).

The following description will discuss each step of the present production method in detail, and then discuss the fine polymer particles (A), the resin (B), etc.

(1-1. Rapid Freezing Step)

The rapid freezing step is a step of rapidly freezing the latex containing the fine polymer particles (A). This step is a step for agglutinating the fine polymer particles (A) contained in the latex. In the present specification, the wording “rapidly freezing” means freezing the latex in 1 second to less than 20 minutes. In this step, the latex may be frozen in 5 seconds to 15 minutes, 15 seconds to 10 minutes, or 20 seconds to 5 minutes.

A specific method of rapidly freezing the latex containing the fine polymer particles (A) is not limited to any particular one, and various techniques relating to instantaneous freezing and rapid freezing can be employed. Preferable examples thereof encompass: a method in which the latex is brought into contact with a metal surface cooled to −80° C. to −10° C.; a method in which the latex is instantaneously cooled and flocculated by spraying the latex into cold air with use of a spray cooler; a method in which the latex is put into a solvent such as liquid nitrogen or cooled alcohol; and a method in which the latex is brought into contact with dry ice or cold stone.

Note that in the present specification, the wording “frozen” means a state where the latex has become solid. In this step, part of the latex may be solid, not less than 50% of the latex may be solid, not less than 70% of the latex may be solid, not less than 80% of the latex may be solid, not less than 90% of the latex may be solid, not less than 98% of the latex may be solid, or 100% of the latex may be solid.

Rapid freezing is such a method that the temperature of the latex passes through a maximum ice crystal formation temperature zone (between −1° C. and −5° C.) in a short period of time in the process of decreasing, and means that the size of an ice crystal is not more than 100 μm. In this step, the size of the ice crystal is preferably not more than 50 μm, more preferably not more than 30 m, more preferably not more than 15 μm, and more preferably not more than 5 μm. The size of the ice crystal is even more preferably not more than 1 μm, not more than 0.8 μm, not more than 0.5 μm, not more than 0.3 am, and not more than 0.2 am, and particularly preferably not more than 0.1 am.

A period of time until the thawing step (described later) is carried out after freezing is not limited to any particular one, but is preferably not longer than 2 weeks, not longer than 1 week, not longer than 2 days, and not longer than 1 day after the freezing. More preferably, the thawing step is carried out without delay after the freezing step. As a period of time for which the latex in a frozen state is stored becomes shorter, it becomes possible to more inhibit growth of the ice crystal, and the dispersibility of the resulting fine polymer particles (A) becomes more favorable.

(1-2. Thawing Step)

The thawing step is a step of thawing the latex which has been frozen in the rapid freezing step. A specific method of thawing the latex is not limited to any particular one, and a known thawing technique can be employed. Examples thereof may encompass: a method in which the latex which has been frozen is restored at an ordinary temperature or in a heating chamber that is heated; a method in which steam is sprayed directly or indirectly on the latex; a method in which hot water is poured on the latex; a method in which a vessel containing the latex is put in hot water; a method in which the latex is brought into contact with a heated metal surface; a method in which the latex is introduced into a heated liquid; and a method in which the latex is irradiated with microwaves. From the viewpoint of productivity, a method in which the latex is brought into contact with a heated metal surface as done by an extruder and a method in which the latex is introduced into a heated liquid are preferable. A period of time in which the latex is thawed is also not limited to any particular one. For example, the latex is thawed in preferably 1 second to 180 minutes, more preferably 1 second to 60 minutes, even more preferably 1 second to 30 minutes, and particularly preferably 1 second to 15 minutes.

(1-3. Resin Mixing Step)

The resin mixing step is a step of mixing, into the latex which has been subjected to the rapid freezing step, the resin (B) having a viscosity of not more than 1,000,000 mPa·s at 25° C. This step is a step for adding the resin (B) to the latex and mixing them.

The resin mixing step may be carried out either before or after the thawing step. Alternatively, the resin mixing step may be carried out simultaneously with the thawing step (in the middle of the thawing step). For example, in a case where the resin mixing step is carried out before the thawing step, the resin mixing step can be carried out as follows: the resin (B) is added to the latex which has been frozen, the latex is subsequently thawed, and then the latex and the resin (B) are mixed. Alternatively, in a case where the resin mixing step is carried out after the thawing step, it is only necessary to (i) add the resin (B) to the latex which has been thawed and (ii) mix them. In a case where the resin mixing step is carried out in the middle of the thawing step, a method can be employed in which (i) the resin (B) is added to the latex which is being thawed and (ii) they are mixed.

A method of mixing the fine polymer particles (A) and the resin (B) is not limited to any particular one, and various methods can be employed. Examples thereof encompass: a method in which the resin (B) is directly added to an aqueous latex of the fine polymer particles (A); and a method in which a solution in which the resin (B) is dissolved is added to the aqueous latex of the fine polymer particles (A).

Furthermore, a means for mixing the fine polymer particles (A) and the resin (B) is not limited to any particular one. For example, (i) the latex containing the fine polymer particles (A) and (ii) the resin (B) can be stirred, kneaded with use of a kneader, kneaded with use of an extruder, and/or mixed with use of a planetary centrifugal mixer.

(1-4. Separating Step)

The separating step is a step of separating the latex into the resin composition, which is the agglutinate containing the fine polymer particles (A) and the resin (B), and the water component, after the thawing step and the resin mixing step. The separating step can be referred to as a step of removing water in the latex which water has been generated in the above-described step, so as to obtain the resin composition which is the agglutinate containing the fine polymer particles (A) and the resin (B).

A method of separating the agglutinate and the water component is not limited to any particular one. Examples thereof encompass methods such as filtration and press dehydration. Note that the water component is a mixture which contains water as a main component and contains an emulsifying agent, the fine polymer particles (A) which have not agglutinated, the resin (B) which have not agglutinated, and the like.

The separating step may include a step of adjusting the water content of the agglutinate to 5% by weight to 60% by weight with respect to 100% by weight of the agglutinate. Setting the water content of the agglutinate within such a range brings about the following advantages. That is, when the obtained resin composition is blended into a thermosetting resin, viscosity does not become excessively high, so that handling is facilitated. Note that, in the present specification, a value measured with use of a moisture measuring device is regarded as the water content of the resin composition. A method of measuring the water content will be described in detail in Examples below.

(1-5. Washing Step)

The present production method preferably further includes a washing step of washing the resin composition obtained in the separating step. By washing the resin composition, which is the agglutinate, the agglutinate which contains few contaminants and the like is obtained. The washing step is carried out by washing the resin composition with more preferably water, and even more preferably ion-exchanged water or pure water.

A specific method of carrying out the washing step is not limited to any particular one, provided that the washing step is a step of washing the resin composition. Examples thereof encompass: a method in which the resin composition and water are mixed and stirred by applying shearing with use of a stirrer, a homomixer, a high shear emulsifier, or the like; a method in which the resin composition and water are kneaded with use of a kneader; and a method in which the resin composition and water are mixed with use of a planetary centrifugal mixer. Examples of the kneader encompass various types of kneaders such as batch type kneaders, continuous type kneaders, and extruders.

A period of time for which the resin composition is washed is not limited to any particular one, and can be, for example, 1 second to 60 minutes. The period of time for which the resin composition is washed is preferably 1 second to 45 minutes, and more preferably 1 second to 30 minutes.

The number of times the resin composition is washed is not limited to any particular one, and can be, for example, 1 to 10. The number of times the resin composition is washed is preferably 1 to 6, and more preferably 1 to 4.

The amount of rinse water is not limited to any particular one, and can be, for example, 0.5 parts by weight to 1000 parts by weight with respect to 1 part by weight of the resin composition. The amount of the rinse water is preferably 1.0 part by weight to 500 parts by weight, and more preferably 1.5 parts by weight to 200 parts by weight. Washing the resin composition by kneading the resin composition with use of a kneader is more preferable, because it is possible to reduce the amount of the rinse water.

The temperature of the rinse water is also not limited. For example, water at an ordinary temperature or heated warm water may be used as appropriate. The temperature of the warm water can be, for example, 10° C. to 100° C., but is preferably 15° C. to 90° C., more preferably 20° C. to 85° C., and particularly preferably 25° C. to 60° C. Since the warm water brings about a higher washing effect, heated rinse water is preferably used. Note that in a case where the resin composition is deteriorated by heat, the resin composition is washed at preferably a lower temperature and washed for preferably a shorter period of time.

A method of removing the rinse water used in the washing step is also not limited to any particular one. Examples thereof encompass wiping away the rinse water, filtration under reduced pressure, oil-water separation, and press dehydration.

(Other Steps)

The method of producing a resin composition in accordance with one or more embodiments of the present invention may include, in addition to the above-described steps, a step of devolatilizing/drying the obtained resin composition by heating the resin composition. Such a step can be achieved by any of various methods which are not limited to any particular ones. Examples thereof encompass heating and vacuum devolatilization.

(1-6. Fine Polymer Particles (A))

The fine polymer particles (A) are not limited to any particular ones, provided that the fine polymer particles (A) are fine particles obtained by polymerization. For example, the fine polymer particles (A) are preferably fine polymer particles having at least a graft part which is constituted by a polymer containing, as one or more structural units, one or more structural units derived from at least one type of monomer selected from the group consisting of aromatic vinyl monomers, vinyl cyanide monomers, and (meth)acrylate monomers. It can be said that the fine polymer particles (A) are constituted by a graft copolymer.

(Graft Part)

In the present specification, a polymer grafted to any polymer is referred to as a graft part. The graft part is a polymer containing, as one or more structural units, one or more structural units derived from at least one type of monomer selected from the group consisting of aromatic vinyl monomers, vinyl cyanide monomers, and (meth)acrylate monomers. The graft part has the above feature, and therefore can play various roles. The “various roles” are, for example, (a) improving compatibility between the fine polymer particles (A) and a thermosetting resin, (b) improving the dispersibility of the fine polymer particles (A) in a thermosetting resin which is a matrix resin with which the resin composition that is the agglutinate containing the fine polymer particles (A) and the resin (B) is mixed, and (c) allowing the fine polymer particles (A) to be dispersed in the form of primary particles in a/the resin composition or in a cured product obtained from the resin composition.

Specific examples of the aromatic vinyl monomers encompass styrene, α-methylstyrene, p-methylstyrene, and divinylbenzene.

Specific examples of the vinyl cyanide monomers encompass acrylonitrile and methacrylonitrile.

Specific examples of the (meth)acrylate monomers encompass methyl (meth)acrylate, ethyl (meth)acrylate, butyl (meth)acrylate, hydroxyethyl (meth)acrylate, and hydroxybutyl (meth)acrylate. In the present specification, (meth)acrylate means acrylate and/or methacrylate.

The at least one type of monomer selected from the group consisting of the aromatic vinyl monomers, the vinyl cyanide monomers, and the (meth)acrylate monomers may be used alone or in combination of two or more.

The graft part preferably contains, as a structural unit, a structural unit derived from a reactive group-containing monomer. The reactive group-containing monomer is preferably a monomer containing at least one type of reactive group selected from the group consisting of an epoxy group, an oxetane group, a hydroxyl group, an amino group, an imide group, a carboxylic acid group, a carboxylic anhydride group, cyclic ester, cyclic amide, a benzoxazine group, and a cyanate ester group, and is more preferably a monomer containing at least one type of reactive group selected from the group consisting of an epoxy group, a hydroxy group, and a carboxylic acid group. According to the above feature, it is possible to chemically bond, in the resin composition, (i) the graft part contained in the fine polymer particles (A) and (ii) a thermosetting resin. Thus, in the resin composition or in the cured product obtained from the resin composition, it is possible to maintain a favorable state of dispersion of the fine polymer particles (A) without causing the fine polymer particles (A) to agglutinate.

Specific examples of a monomer having an epoxy group encompass glycidyl (meth)acrylate, 4-hydroxybutyl (meth)acrylate glycidyl ether, and allyl glycidyl ether.

Specific examples of a monomer having a hydroxyl group encompass: hydroxy straight-chain alkyl (meth)acrylates (in particular, hydroxy straight-chain C1-C6 alkyl(meth)acrylates) such as 2-hydroxyethyl (meth)acrylate, hydroxypropyl (meth)acrylate, and 4-hydroxybutyl (meth)acrylate; caprolactone-modified hydroxy (meth)acrylate; hydroxy branching alkyl (meth)acrylates such as α-(hydroxymethyl) methyl acrylate and α-(hydroxymethyl) ethyl acrylate; and hydroxyl group-containing (meth)acrylates such as a mono (meth)acrylate of a polyester diol (particularly saturated polyester diol) obtained from dicarboxylic acid (e.g. phthalic acid) and dihydric alcohol (e.g. propylene glycol).

Specific examples of a monomer having a carboxylic acid group encompass monocarboxylic acids such as acrylic acid, methacrylic acid, and crotonic acid. Other examples of the monomer encompass dicarboxylic acids such as maleic acid, fumaric acid, and itaconic acid. As the monomer having a carboxylic acid group, the monocarboxylic acid is suitably used.

The above-listed reactive group-containing monomers may be used alone or in combination of two or more.

The graft part contains the structural unit derived from the reactive group-containing monomer in an amount of preferably 0.5% by weight to 90% by weight, more preferably 1% by weight to 50% by weight, even more preferably 2% by weight to 35% by weight, particularly preferably 3% by weight to 20% by weight, with respect to 100% by weight of the graft part. In a case where the graft part contains the structural unit derived from the reactive group-containing monomer in an amount of not less than 0.5% by weight with respect to 100% by weight of the graft part, the resulting resin composition has an advantage that the resin composition can provide the cured product which has enough impact resistance. In a case where the graft part contains the structural unit derived from the reactive group-containing monomer in an amount of not more than 90% by weight with respect to 100% by weight of the graft part, the resulting resin composition has advantages that (i) the resin composition can provide the cured product which has sufficient impact resistance and (ii) the resin composition has favorable storage stability.

The structural unit derived from the reactive group-containing monomer is preferably contained in the graft part, and more preferably contained only in the graft part.

The graft part may contain, as a structural unit, a structural unit derived from a polyfunctional monomer. In a case where the graft part contains the structural unit derived from the polyfunctional monomer, there are the following advantages, for example: (a) it is possible to prevent swelling of the fine polymer particles (A) in the resin composition; (b) since the resin composition has a low viscosity, the resin composition tends to have favorable handleability; and (c) the dispersibility of the fine polymer particles (A) in a thermosetting resin is improved.

In a case where the graft part does not contain the structural unit derived from the polyfunctional monomer, the resulting resin composition can provide the cured product which has more excellent toughness and impact resistance, as compared to a case where the graft part contains the structural unit derived from the polyfunctional monomer.

It can also be said that the polyfunctional monomer is a monomer having two or more radical-polymerizable reactive groups in an identical molecule. The radical-polymerizable reactive groups are each preferably a carbon-carbon double bond. Examples of the polyfunctional monomer do not encompass butadiene. The polyfunctional monomer is, for example, a (meth)acrylate having an ethylenically unsaturated double bond(s), such as allyl (meth)acrylate. Examples of a monomer having two (meth)acrylic groups encompass ethylene glycol di(meth)acrylate, butanediol di(meth)acrylate, hexanediol di(meth)acrylate, cyclohexane dimethanol di(meth)acrylate, and polyethylene glycol di(meth)acrylates. Examples of the polyethylene glycol di(meth)acrylates encompass triethylene glycol di(meth)acrylate, tripropylene glycol di(meth)acrylate, tetraethylene glycol di(meth)acrylate, and polyethylene glycol (600) di(meth)acrylate. Examples of a monomer having three (meth)acrylate groups encompass alkoxylated trimethylolpropane tri(meth)acrylates, glycerol propoxy tri(meth)acrylate, pentaerythritol tri(meth)acrylate, and tris(2-hydroxyethyl)isocyanurate tri(meth)acrylate. Examples of the alkoxylated trimethylolpropane tri(meth)acrylates encompass trimethylolpropane tri(meth)acrylate and trimethylolpropane triethoxy tri(meth)acrylate. Examples of a monomer having four (meth)acrylic groups encompass pentaerythritol tetra(meth)acrylate and ditrimethylolpropane tetra(meth)acrylate. Examples of a monomer having five (meth)acrylic groups encompass dipentaerythritol penta(meth)acrylate. Examples of a monomer having six (meth)acrylic groups encompass ditrimethylolpropane hexa(meth)acrylate.

Out of such polyfunctional monomers, examples of a polyfunctional monomer which can be preferably used to form the graft part by polymerization encompass allyl methacrylate, ethylene glycol di(meth)acrylate, butanediol di(meth)acrylate, hexanediol di(meth)acrylate, cyclohexane dimethanol di(meth)acrylate, and polyethylene glycol di(meth)acrylates. The above-listed polyfunctional monomers may be used alone or in combination of two or more.

The graft part contains the structural unit derived from the polyfunctional monomer in an amount of preferably 1% by weight to 20% by weight, more preferably 5% by weight to 15% by weight, with respect to 100% by weight of the graft part.

The graft part may contain, as a structural unit, a structural unit derived from another monomer, in addition to the structural units derived from the above-listed monomers.

The graft part is preferably a polymer grafted to an elastic body (described later).

(Glass Transition Temperature of Graft Part)

The graft part has a glass transition temperature of preferably not higher than 190° C., more preferably not higher than 160° C., more preferably not higher than 140° C., more preferably not higher than 120° C., more preferably not higher than 80° C., more preferably not higher than 70° C., more preferably not higher than 60° C., more preferably not higher than 50° C., more preferably not higher than 40° C., more preferably not higher than 30° C., more preferably not higher than 20° C., more preferably not higher than 10° C., more preferably not higher than 0° C., more preferably not higher than −20° C., more preferably not higher than −40° C., more preferably not higher than −45° C., more preferably not higher than −50° C., more preferably not higher than −55° C., more preferably not higher than −60° C., more preferably not higher than −65° C., more preferably not higher than −70° C., more preferably not higher than −75° C., more preferably not higher than −80° C., more preferably not higher than −85° C., more preferably not higher than −90° C., more preferably not higher than −95° C., more preferably not higher than −100° C., more preferably not higher than −105° C., more preferably not higher than −110° C., more preferably not higher than −115° C., even more preferably not higher than −120° C., particularly preferably not higher than −125° C.

The glass transition temperature of the graft part is preferably not lower than 0° C., more preferably not lower than 30° C., more preferably not lower than 50° C., more preferably not lower than 70° C., even more preferably not lower than 90° C., particularly preferably not higher than 110° C.

The Tg of the graft part can be determined by, for example, the composition of the structural unit contained in the graft part. In other words, it is possible to adjust the Tg of the resulting graft part, by changing the composition of the monomer used to produce (form) the graft part.

The Tg of the graft part can be obtained by carrying out viscoelasticity measurement with use of a planar plate made of the fine polymer particles. Specifically, the Tg can be measured as follows: (1) a graph of tan 6 is obtained by carrying out dynamic viscoelasticity measurement with respect to a planar plate made of the fine polymer particles, with use of a dynamic viscoelasticity measurement device (for example, DVA-200, manufactured by IT Keisoku Seigyo Kabushikigaisha) under a tension condition; and (2) in the graph of tan 6 thus obtained, the peak temperature of tan 6 is regarded as the glass transition temperature. Note, here, that in a case where a plurality of peaks are found in the graph of tan 6, the highest peak temperature is regarded as the glass transition temperature of the graft part.

(Graft Rate of Graft Part)

In one or more embodiments of the present invention, the fine polymer particles (A) may have a polymer which is identical in composition to the graft part and which is not grafted to the elastic body (described later). In the present specification, the polymer which is identical in composition to the graft part and which is not grafted to the elastic body may be referred to as a “non-grafted polymer”. The non-grafted polymer also constitutes part of the fine polymer particles (A) in accordance with one or more embodiments of the present invention. It can also be said that the non-grafted polymer is one that is not grafted to the elastic body (described later), out of polymers produced during formation of the graft part by polymerization.

In the present specification, the proportion of (i) the polymer which is grafted to the elastic body (described later) to (ii) the polymers produced during the formation of the graft part by polymerization, i.e., the proportion of the graft part, is referred to as a “graft rate”. In other words, the graft rate is a value represented by the following expression: (weight of graft part)/{(weight of graft part)+(weight of non-grafted polymer)}×100.

The graft rate of the graft part is preferably not less than 70%, more preferably not less than 80%, even more preferably not less than 90%. In a case where the graft rate is not less than 70%, there is an advantage that the resin composition does not have an excessively high viscosity.

Note that in the present specification, the graft rate is calculated by the following method. First, an aqueous latex containing the fine polymer particles (A) is obtained. Next, a powder of the fine polymer particles (A) is obtained from the aqueous latex. A specific example of a method of obtaining the powder of the fine polymer particles (A) from the aqueous latex is a method of obtaining the powder of the fine polymer particles (A) by (i) causing the fine polymer particles (A) in the aqueous latex to coagulate, (ii) dehydrating a coagulate thus obtained, and (iii) further drying the coagulate. Next, 2 g of the powder of the fine polymer particles (A) is dissolved in 50 mL of methyl ethyl ketone (hereinafter also referred to as MEK). An MEK solution of the powder thus obtained is separated into a part soluble in MEK (MEK-soluble part) and a part insoluble in MEK (MEK-insoluble part). Specifically, the obtained MEK solution of the powder is subjected to centrifugal separation with use of a centrifugal separator (CP60E, manufactured by Hitachi Koki Co., Ltd.) at 30000 rpm for 1 hour, and thereby separated into the MEK-soluble part and the MEK-insoluble part. Note, here, that three sets of centrifugal separations are carried out in total. The weight of the MEK-soluble part and the weight of the MEK-insoluble part are measured, and then the graft rate is calculated with use of the following expression.

Graft rate (%)={(weight of methyl ethyl ketone insoluble part)−(weight of polymer other than graft part)}/(weight of polymer other than graft part)×100

Note that the weight of the polymer other than the graft part is the amount of a monomer introduced for formation of the polymer other than the graft part. The polymer other than the graft part is, for example, the elastic body. In a case where the fine polymer particles (A) contain a surface-crosslinked polymer (described later), the polymer other than the graft part includes both the elastic body and the surface-crosslinked polymer. In calculation of the graft rate, a method of causing the fine polymer particles (A) to coagulate is not limited to any particular one, and a method in which a solvent is used, a method in which a coagulant is used, a method in which the aqueous latex is sprayed, or the like can be employed.

(Variations of Graft Part)

In one or more embodiments of the present invention, the graft part may be constituted by only one type of graft part which has a structural unit having identical composition. In one or more embodiments of the present invention, the graft part may be constituted by plural types of graft parts which have structural units different from each other in composition.

In one or more embodiments of the present invention, a case where the graft part is constituted by plural types of graft parts will be described. In this case, the plural types of graft parts will be referred to as a graft part₁, a graft part₂, . . . a graft partₙ(“n” is an integer of 2 or more). The graft part may include a mixture obtained by mixing the graft part₁, the graft part₂ . . . , and the graft partₙ which are separately formed by polymerization. The graft part may include a polymer obtained by forming the graft part₁, the graft part₂, . . . , and the graft partₙ in order by polymerization. Forming a plurality of polymers (graft parts) in order by polymerization in this manner is also referred to as multistage polymerization. A polymer obtained by forming plural types of graft parts by multistage polymerization is also referred to as a multistage-polymerization graft part. A method of producing a multistage-polymerization graft part will be later described in detail.

In a case where the graft part is constituted by the plural types of graft parts, all of the plural types of graft parts do not need to be grafted to the elastic body. It is only necessary that at least part of at least one of the plural types of graft parts be grafted to the elastic body. The other of the plural types of graft parts may be grafted to the at least one of the plural types of graft parts which is grafted to the elastic body. In a case where the graft part is constituted by the plural types of graft parts, the graft part may have plural types of polymers which are identical in feature to the plural types of graft parts and which are not grafted to the elastic body (plural types of non-grafted polymers).

The multistage-polymerization graft part constituted by the graft part₁, the graft part₂, . . . the graft partₙ will be described. In the multistage-polymerization graft part, the graft partₙ can cover at least part of a graft partₙ. 1 or the whole of the graft partₙ₋₁. In the multistage-polymerization graft part, part of the graft partₙ may be located inside the graft partₙ₋₁.

In the multistage-polymerization graft part, the graft parts may have a layer structure. For example, in a case where the multistage-polymerization graft part is constituted by the graft part₁, the graft part₂, and a graft part₃, aspects of one or more embodiments of the present invention also include an aspect such that the graft part₁ forms the innermost layer of the graft part, a layer of the graft part₂ is present on the outer side of the graft part₁, and a layer of the graft part₃ is present on the outer side of the layer of the graft part₂ as the outermost layer. Thus, it can also be said that the multistage-polymerization graft part in which the graft parts have a layer structure is a multilayered graft part. In other words, in one or more embodiments of the present invention, the graft part may include a mixture of plural types of graft parts, a multistage-polymerization graft part, and/or a multilayered graft part.

In a case where the elastic body and the graft part are formed in this order by polymerization in production of the fine polymer particles (A), at least part of the graft part can cover at least part of the elastic body in the resulting fine polymer particles (A). The wording “the elastic body and the graft part are formed in this order by polymerization” can be reworded as follows: the elastic body and the graft part are formed by multistage polymerization. It can also be said that the fine polymer particles (A) obtained by forming the elastic body and the graft part by multistage polymerization is a multistage polymer.

In a case where the fine polymer particles (A) are constituted by a multistage polymer, the graft part can cover at least part of the elastic body or the whole of the elastic body. In a case where the fine polymer particles (A) are constituted by a multistage polymer, part of the graft part may be located inside the elastic body.

In a case where the fine polymer particles (A) are constituted by a multistage polymer, the elastic body and the graft part may have a layer structure. For example, aspects of one or more embodiments of the present invention also include an aspect such that the elastic body is present as the innermost layer (also referred to as a core layer) and a layer of the graft part is present on the outer side of the elastic body as the outermost layer (also referred to as a shell layer). It can also be said that a structure in which the elastic body is present as a core layer and the graft part is present as a shell layer is a core-shell structure. It can also be said that the fine polymer particles (A) which contain the elastic body and the graft part which have a layer structure (core-shell structure) are constituted by a multilayered polymer or a core-shell polymer. In other words, in one or more embodiments of the present invention, the fine polymer particles (A) may be constituted by a multistage polymer and/or a multilayered polymer or a core-shell polymer. Note, however, that the fine polymer particles (A) are not limited to the above feature, provided that the fine polymer particles (A) have the graft part.

At least part of the graft part preferably covers at least part of the elastic body. In other words, at least part of the graft part is preferably present on the outermost side of the fine polymer particles (A).

(Elastic Body)

The fine polymer particles (A) preferably further have the elastic body. That is, the fine polymer particles (A) are preferably constituted by a rubber-containing graft copolymer which has the elastic body and the graft part grafted to the elastic body. The following description will discuss one or more embodiments of the present invention while taking as an example a case where the fine polymer particles (A) are constituted by a rubber-containing graft copolymer.

The elastic body preferably includes at least one type of elastic body selected from the group consisting of diene-based rubbers, (meth)acrylate-based rubbers, and polysiloxane rubber-based elastic bodies. The elastic body can also be referred to as rubber particles.

A case where the fine polymer particles (A) contain a diene-based rubber (case A) will be described. In the case A, in a case where the elastic body includes a diene-based rubber, the resulting resin composition can provide the cured product which has excellent toughness and impact resistance.

The diene-based rubber is an elastic body containing, as a structural unit, a structural unit derived from a diene-based monomer. The diene-based monomer can also be referred to as a conjugated diene-based monomer. In the case A, the diene-based rubber may contain (i) the structural unit derived from the diene-based monomer in an amount of 50% by weight to 100% by weight and (ii) a structural unit derived from a vinyl-based monomer, which is different from the diene-based monomer and which is copolymerizable with the diene-based monomer, in an amount of 0% by weight to 50% by weight, with respect to 100% by weight of structural units. In the case A, the diene-based rubber may contain, as a structural unit, a structural unit derived from a (meth)acrylate-based monomer in an amount smaller than the amount of the structural unit derived from the diene-based monomer.

Examples of the diene-based monomer encompass 1,3-butadiene, isoprene (2-methyl-1,3-butadiene), and 2-chloro-1,3-butadiene. These monomers may be used alone or in combination of two or more.

Examples of the vinyl-based monomer which is different from the diene-based monomer and which is copolymerizable with the diene-based monomer (hereinafter also referred to as vinyl-based monomer A) encompass: vinyl arenes such as styrene, α-methylstyrene, monochlorostyrene, and dichlorostyrene; vinyl carboxylic acids such as acrylic acid and methacrylic acid; vinyl cyanides such as acrylonitrile and methacrylonitrile; vinyl halides such as vinyl chloride, vinyl bromide, and chloroprene; vinyl acetate; alkenes such as ethylene, propylene, butylene, and isobutylene; and polyfunctional monomers such as diallylphthalate, triallyl cyanurate, triallyl isocyanurate, and divinylbenzene. These vinyl-based monomers which are different from the diene-based monomer may be used alone or in combination of two or more. Out of these vinyl-based monomers which are different from the diene-based monomer, styrene is particularly preferable. Note that, in the diene-based rubber in the case A, the structural unit derived from the vinyl-based monomer which is different from the diene-based monomer is an optional component. Note that, in the case A, the diene-based rubber may be constituted by only the structural unit derived from the diene-based monomer.

In the case A, the diene-based rubber is preferably (i) butadiene rubber which is constituted by a structural unit derived from 1,3-butadiene (also referred to as polybutadiene rubber) or (ii) butadiene-styrene rubber which is a copolymer of 1,3-butadiene and styrene (also referred to as polystyrene-butadiene). The diene-based rubber is more preferably butadiene rubber. According to the above feature, since the fine polymer particles (A) contain the diene-based rubber, a desired effect can be more brought about. The butadiene-styrene rubber is more preferable in that the butadiene-styrene rubber makes it possible to, by adjustment of a refractive index, increase the transparency of the resulting cured product.

A case where the elastic body includes a (meth)acrylate-based rubber (case B) will be described. The case B allows wide-ranging polymer design for the elastic body by combinations of many types of monomers.

The (meth)acrylate-based rubber is an elastic body containing, as a structural unit, a structural unit derived from a (meth)acrylate-based monomer. In the case B, the (meth)acrylate-based rubber may contain (i) the structural unit derived from the (meth)acrylate-based monomer in an amount of 50% by weight to 100% by weight and (ii) a structural unit derived from a vinyl-based monomer, which is different from the (meth)acrylate-based monomer and which is copolymerizable with the (meth)acrylate-based monomer, in an amount of 0% by weight to 50% by weight, with respect to 100% by weight of structural units. In the case B, the (meth)acrylate-based rubber may contain, as a structural unit, a structural unit derived from a diene-based monomer in an amount smaller than the amount of the structural unit derived from the (meth)acrylate-based monomer.

Examples of the (meth)acrylate-based monomer encompass: alkyl (meth)acrylates such as methyl (meth)acrylate, ethyl (meth)acrylate, butyl (meth)acrylate, 2-ethylhexyl (meth)acrylate, octyl (meth)acrylate, dodecyl (meth)acrylate, stearyl (meth)acrylate, and behenyl (meth)acrylate; aromatic ring-containing (meth)acrylates such as phenoxyethyl (meth)acrylate and benzyl (meth)acrylate; hydroxyalkyl (meth)acrylates such as 2-hydroxyethyl (meth)acrylate and 4-hydroxybutyl (meth)acrylate; glycidyl (meth)acrylates such as glycidyl (meth)acrylate and glycidyl alkyl (meth)acrylate; alkoxy alkyl (meth)acrylates; allyl alkyl (meth)acrylates such as allyl (meth)acrylate and allyl alkyl (meth)acrylate; and polyfunctional (meth)acrylates such as monoethylene glycol di(meth)acrylate, triethylene glycol di(meth)acrylate, and tetraethylene glycol di(meth)acrylate. These (meth)acrylate-based monomers may be used alone or in combination of two or more. Out of these (meth)acrylate-based monomers, ethyl (meth)acrylate, butyl (meth)acrylate, and 2-ethylhexyl (meth)acrylate are particularly preferable.

Examples of the vinyl-based monomer which is different from the (meth)acrylate-based monomer and which is copolymerizable with the (meth)acrylate-based monomer (hereinafter also referred to as vinyl-based monomer which is different from the (meth)acrylate-based monomer) encompass the monomers listed as the examples of the vinyl-based monomer A. Such vinyl-based monomers which are different from the (meth)acrylate-based monomer may be used alone or in combination of two or more. Out of such vinyl-based monomers which are different from the (meth)acrylate-based monomer, styrene is particularly preferable. Note that, in the (meth)acrylate-based rubber in the case B, the structural unit derived from the vinyl-based monomer which is different from the (meth)acrylate-based monomer is an optional component. Note that, in the case B, the (meth)acrylate-based rubber may be constituted by only the structural unit derived from the (meth)acrylate-based monomer.

A case where the elastic body includes a polysiloxane rubber-based elastic body (case C) will be described. In the case C, the resulting resin composition can provide the cured product which has sufficient heat resistance and which has excellent impact resistance at low temperatures.

Example of the polysiloxane rubber-based elastic body encompass (a) polysiloxane-based polymers composed of alkyl or aryl disubstituted silyloxy units, such as dimethylsilyloxy, diethylsilyloxy, methylphenylsilyloxy, diphenylsilyloxy, and dimethylsilyloxy-diphenylsilyloxy, and (b) polysiloxane-based polymers composed of alkyl or aryl monosubstituted silyloxy units, such as organohydrogensilyloxy in which some of sidechain alkyls have been substituted with a hydrogen atom. These polysiloxane-based polymers may be used alone or in combination of two or more. Out of these polysiloxane-based polymers, (a) a polymer composed of a dimethylsilyloxy unit, a methylphenylsilyloxy unit, and/or a dimethylsilyloxy-diphenylsilyloxy unit is preferable because the resulting resin composition can provide the cured product which has excellent heat resistance, and (b) a polymer composed of a dimethylsilyloxy unit is most preferable because it can be easily acquired and is economical.

In the case C, the fine polymer particles (A) contain the polysiloxane rubber-based elastic body in an amount of preferably not less than 80% by weight, more preferably not less than 90% by weight, with respect to 100% by weight of the elastic body contained in the fine polymer particles (A). According to the above feature, the resulting resin composition can provide the cured product which has excellent heat resistance.

The elastic body may further include an elastic body other than the diene-based rubber, the (meth)acrylate-based rubber, and the polysiloxane rubber-based elastic body. Examples of the elastic body other than the diene-based rubber, the (meth)acrylate-based rubber, and the polysiloxane rubber-based elastic body encompass natural rubber.

(Crosslinked Structure of Elastic Body)

The elastic body preferably has a crosslinked structure introduced therein, from the viewpoint of maintenance of stable dispersion of the fine polymer particles (A) in a thermosetting resin. A generally used method may be used to introduce the crosslinked structure into the elastic body. Examples of the generally used method encompass the following. That is, in production of the elastic body, a crosslinking monomer(s), such as a polyfunctional monomer and/or a mercapto group-containing compound, is/are mixed with a monomer which can constitute the elastic body, and then polymerization is carried out. In the present specification, producing a polymer such as the elastic body is also referred to as forming a polymer by polymerization.

Examples of a method of introducing the crosslinked structure into the polysiloxane rubber-based elastic body encompass: (a) a method that involves also partially using a polyfunctional alkoxysilane compound together with another material during formation of the polysiloxane rubber-based elastic body by polymerization; (b) a method that involves introducing into the polysiloxane rubber-based elastic body a reactive group such as a reactive vinyl group or a mercapto group, thereafter adding e.g. an organic peroxide or a polymerizable vinyl monomer, and carrying out a radical reaction; and (c) a method that involves, during formation of the polysiloxane rubber-based elastic body by polymerization, mixing a crosslinking monomer(s), such as a polyfunctional monomer and/or a mercapto group-containing compound, together with another material and then carrying out polymerization.

Examples of the polyfunctional monomer encompass the polyfunctional monomers listed as the examples in the section (Graft part).

Examples of the mercapto group-containing compound encompass alkyl group-substituted mercaptan, allyl group-substituted mercaptan, aryl group-substituted mercaptan, hydroxy group-substituted mercaptan, alkoxy group-substituted mercaptan, cyano group-substituted mercaptan, amino group-substituted mercaptan, silyl group-substituted mercaptan, acid group-substituted mercaptan, halo group-substituted mercaptan, and acyl group-substituted mercaptan. The alkyl group-substituted mercaptan is preferably C1-C20 alkyl group-substituted mercaptan, and is more preferably C1-C10 alkyl group-substituted mercaptan. The aryl group-substituted mercaptan is preferably phenyl group-substituted mercaptan. The alkoxy group-substituted mercaptan is preferably C1-C20 alkoxy group-substituted mercaptan, and is more preferably C1-C10 alkoxy group-substituted mercaptan. The acid group-substituted mercaptan is preferably C1-C10 alkyl group-substituted mercaptan having a carboxyl group or C1-C12 aryl group-substituted mercaptan having a carboxyl group.

(Glass Transition Temperature of Elastic Body)

The elastic body has a glass transition temperature of preferably not higher than 80° C., more preferably not higher than 70° C., more preferably not higher than 60° C., more preferably not higher than 50° C., more preferably not higher than 40° C., more preferably not higher than 30° C., more preferably not higher than 20° C., more preferably not higher than 10° C., more preferably not higher than 0° C., more preferably not higher than −20° C., more preferably not higher than −40° C., more preferably not higher than −45° C., more preferably not higher than −50° C., more preferably not higher than −55° C., more preferably not higher than −60° C., more preferably not higher than −65° C., more preferably not higher than −70° C., more preferably not higher than −75° C., more preferably not higher than −80° C., more preferably not higher than −85° C., more preferably not higher than −90° C., more preferably not higher than −95° C., more preferably not higher than −100° C., more preferably not higher than −105° C., more preferably not higher than −110° C., more preferably not higher than −115° C., even more preferably not higher than −120° C., particularly preferably not higher than −125° C. In the present specification, the “glass transition temperature” may be referred to as “Tg”. According to the above feature, it is possible to obtain a powdery and/or granular material having a low Tg. As a result, the resin composition which contains the resulting powdery and/or granular material can provide the cured product or a molded product each of which has excellent toughness. The Tg of the elastic body can be obtained by carrying out viscoelasticity measurement with use of a planar plate made of the elastic body. Specifically, the Tg can be measured as follows: (1) a graph of tan δ is obtained by carrying out dynamic viscoelasticity measurement with respect to a planar plate made of the elastic body, with use of a dynamic viscoelasticity measurement device (for example, DVA-200, manufactured by IT Keisoku Seigyo Kabushikigaisha) under a tension condition; and (2) in the graph of tan δ thus obtained, the peak temperature of tan δ is regarded as the glass transition temperature. Note, here, that in a case where a plurality of peaks are found in the graph of tan δ, the lowest peak temperature is regarded as the glass transition temperature of the elastic body.

In view of prevention of a decrease in elastic modulus (i.e., a decrease in rigidity) of the resulting cured product, i.e., in view of obtainment of the cured product which has a sufficient elastic modulus (rigidity), the Tg of the elastic body is preferably higher than 0° C., more preferably not lower than 20° C., even more preferably not lower than 50° C., particularly preferably not lower than 80° C., most preferably not lower than 120° C.

The Tg of the elastic body can be determined by, for example, the composition of the structural unit contained in the elastic body. In other words, it is possible to adjust the Tg of the resulting elastic body, by changing the composition of the monomer used to produce (form) the elastic body.

Note, here, that monomers each of which, when polymerized to form a homopolymer (i.e., a polymer obtained by polymerizing only one type of monomer), provides a homopolymer having a Tg of higher than 0° C. will be referred to as a monomer group “a”. Note also that monomers each of which, when polymerized to form a homopolymer (i.e., a polymer obtained by polymerizing only one type of monomer), provides a homopolymer having a Tg of lower than 0° C. will be referred to as a monomer group “b”. Note also that an elastic body containing (i) one or more structural units derived from at least one type of monomer selected from the monomer group “a” in an amount of 50% by weight to 100% by weight (more preferably 65% by weight to 99% by weight) and (ii) one or more structural units derived from at least one type of monomer selected from the monomer group “b” in an amount of 0% by weight to 50% by weight (more preferably 1% by weight to 35% by weight) will be referred to as an elastic body X. The elastic body X has a Tg higher than 0° C. In a case where the elastic body includes the elastic body X, the resulting resin composition can provide the cured product which has sufficient rigidity.

Also in a case where the Tg of the elastic body is higher than 0° C., the crosslinked structure may be introduced in the elastic body. Examples of a method of introducing the crosslinked structure into the elastic body encompass the above-described methods.

Examples of the monomers which can be included in the monomer group “a” encompass, but are not limited to, unsubstituted vinyl aromatic compounds such as styrene and 2-vinyl naphthalene; vinyl-substituted aromatic compounds such as α-methyl styrene; ring-alkylated vinyl aromatic compounds such as 3-methylstyrene, 4-methylstyrene, 2,4-dimethylstyrene, 2,5-dimethylstyrene, 3,5-dimethylstyrene, and 2,4,6-trimethylstyrene; ring-alkoxylated vinyl aromatic compounds such as 4-methoxystyrene and 4-ethoxystyrene; ring-halogenated vinyl aromatic compounds such as 2-chlorostyrene and 3-chlorostyrene; ring-ester-substituted vinyl aromatic compounds such as 4-acetoxy styrene; ring-hydroxylated vinyl aromatic compounds such as 4-hydroxystyrene; vinyl esters such as vinyl benzoate and vinyl cyclohexanoate; vinyl halides such as vinyl chloride; aromatic monomers such as acenaphthalene and indene; alkyl methacrylates such as methyl methacrylate, ethyl methacrylate, and isopropyl methacrylate; aromatic methacrylates such as phenyl methacrylate; methacrylates such as isobornyl methacrylate and trimethylsilyl methacrylate; methacrylic acid derivative-containing methacryl monomers such as methacrylonitrile; certain types of acrylic acid esters such as isobornyl acrylate and tert-butyl acrylate; and acrylic acid derivative-containing acrylic monomers such as acrylonitrile. Examples of the monomers which can be included in the monomer group “a” further encompass monomers each of which, when polymerized, can provide a homopolymer having a Tg of not lower than 120° C., such as acrylamide, isopropyl acrylamide, N-vinylpyrrolidone, isobornyl methacrylate, dicyclopentanyl methacrylate, 2-methyl-2-adamanthyl methacrylate, 1-adamanthyl acrylate, and 1-adamanthyl methacrylate. These monomers “a” may be used alone or in combination of two or more.

Examples of monomers “b” encompass ethyl acrylate, butyl acrylate, 2-ethylhexyl acrylate, octyl (meth)acrylate, dodecyl (meth)acrylate, 2-hydroxyethyl acrylate, and 4-hydroxybutyl acrylate. These monomers “b” may be used alone or in combination of two or more. Out of these monomers “b”, ethyl acrylate, butyl acrylate, and 2-ethylhexyl acrylate are particularly preferable.

(Volume-Average Particle Size of Elastic Body)

The elastic body has a volume-average particle size of preferably 0.03 m to 50.00 μm, more preferably 0.05 μm to 10.00 μm, more preferably 0.08 m to 2.00 μm, even more preferably 0.10 μm to 1.00 μm, still more preferably 0.10 μm to 0.80 μm, particularly preferably 0.10 μm to 0.50 μm. In a case where the volume-average particle size of the elastic body is not less than 0.03 m, the elastic body which has a desired volume-average particle size can be stably obtained. In a case where the volume-average particle size of the elastic body is not more than 50.00 μm, the resulting cured product or molded product has favorable heat resistance and impact resistance. The volume-average particle size of the elastic body can be measured with use of a dynamic light scattering type particle size distribution measurement apparatus using, as a test specimen, an aqueous latex containing the elastic body. A method of measuring the volume-average particle size of the elastic body will be described in detail in Examples below.

(Proportion of Elastic Body)

The proportion of the elastic body contained in the fine polymer particles (A) is preferably 40% by weight to 97% by weight, more preferably 60% by weight to 95% by weight, even more preferably 70% by weight to 93% by weight, where 100% by weight represents the entirety of the fine polymer particles (A). In a case where the proportion of the elastic body is not less than 40% by weight, the resulting resin composition can provide the cured product which has excellent toughness and impact resistance. In a case where the proportion of the elastic body is not more than 97% by weight, the fine polymer particles (A) do not easily agglutinate and, therefore, the resin composition does not have a high viscosity, so that the resulting resin composition can be excellent in handling.

(Gel Content of Elastic Body)

The elastic body is preferably one that can swell in an appropriate solvent but is substantially insoluble in the appropriate solvent. The elastic body is preferably insoluble in a thermosetting resin used.

The elastic body has a gel content of preferably not less than 60% by weight, more preferably not less than 80% by weight, even more preferably not less than 90% by weight, particularly preferably not less than 95% by weight. In a case where the gel content of the elastic body falls within the above range, the resulting resin composition can provide the cured product which has excellent toughness.

In the present specification, a method of calculating the gel content is as follows. First, an aqueous latex containing the fine polymer particles (A) is obtained. Next, a powdery and/or granular material of the fine polymer particles (A) is obtained from the aqueous latex. A method of obtaining the powdery and/or granular material of the fine polymer particles (A) from the aqueous latex is not limited to any particular one, and examples thereof encompass a method of obtaining the powdery and/or granular material of the fine polymer particles (A) by (i) causing the fine polymer particles (A) in the aqueous latex to aggregate, (ii) dehydrating an aggregate thus obtained, and (iii) further drying the aggregate. Next, 2.0 g of the powdery and/or granular material of the fine polymer particles (A) is dissolved in 50 mL of methyl ethyl ketone (MEK). An MEK solution of the powdery and/or granular material thus obtained is separated into a part soluble in MEK (MEK-soluble part) and a part insoluble in MEK (MEK-insoluble part). Specifically, the obtained MEK solution of the powdery and/or granular material is subjected to centrifugal separation with use of a centrifugal separator (CP60E, manufactured by Hitachi Koki Co., Ltd.) at 30000 rpm for 1 hour, and thereby separated into the MEK-soluble part and the MEK-insoluble part. Note, here, that three sets of centrifugal separations are carried out in total. The weight of the MEK-soluble part and the weight of the MEK-insoluble part are measured, and then the gel content is calculated with use of the following expression.

Gel content (%)=(weight of methyl ethyl ketone insoluble part)/{(weight of methyl ethyl ketone insoluble part)+(weight of methyl ethyl ketone soluble part)}×100

(Variations of Elastic Body)

In one or more embodiments of the present invention, the elastic body may be constituted by only one type of elastic body which has a structural unit having identical composition and which is selected from the group consisting of diene-based rubbers, (meth)acrylate-based rubbers, and polysiloxane rubber-based elastic bodies. In one or more embodiments of the present invention, the elastic body may be constituted by plural types of elastic bodies which have structural units different from each other in composition.

In one or more embodiments of the present invention, a case where the elastic body is constituted by plural types of elastic bodies will be described. In this case, the plural types of elastic bodies will be referred to as an elastic body₁, an elastic body₂, . . . and an elastic bodyₙ. Note, here, that “n” is an integer of 2 or more. The elastic body may include a mixture obtained by mixing the elastic body₁, the elastic body₂, . . . , and the elastic bodyₙ which are separately formed by polymerization. The elastic body may include a polymer obtained by forming the elastic body₁, the elastic body₂, . . . , and the elastic bodyₙ by multistage polymerization. A polymer obtained by forming plural types of elastic bodies by multistage polymerization is also referred to as a multistage-polymerization elastic body. A method of producing a multistage-polymerization elastic body will be later described in detail.

A multistage-polymerization elastic body constituted by the elastic body₁, the elastic body₂, . . . and the elastic body₁ will be described. In the multistage-polymerization elastic body, the elastic bodyₙ can cover at least part of an elastic bodyₙ₋₁ or the whole of the elastic bodyₙ₋₁. In the multistage-polymerization elastic body, part of the elastic bodyₙ may be located inside the elastic bodyₙ₋₁.

In the multistage-polymerization elastic body, the elastic bodies may have a layer structure. For example, in a case where the multistage-polymerization elastic body is constituted by the elastic body₁, the elastic body₂, and an elastic body₃, aspects of one or more embodiments of the present invention also include an aspect such that the elastic body₁ forms the innermost layer, a layer of the elastic body₂ is present on the outer side of the elastic body₁, and a layer of the elastic body₃ is present on the outer side of the layer of the elastic body₂ as the outermost layer of the elastic body. Thus, it can also be said that the multistage-polymerization elastic body in which the elastic bodies have a layer structure is a multilayered elastic body. In other words, in one or more embodiments of the present invention, the elastic body may include a mixture of plural types of elastic bodies, a multistage-polymerization elastic body, and/or a multilayered elastic body.

(Surface-Crosslinked Polymer)

The fine polymer particles (A) preferably have a surface-crosslinked polymer in addition to the elastic body and the graft part grafted to the elastic body. The above feature (a) allows an improvement of an anti-blocking property in the production of the fine polymer particles (A) and (b) makes the dispersibility of the fine polymer particles (A) in a thermosetting resin more favorable. Reasons for these are not limited to any particular ones, but can be inferred as follows. By the surface-crosslinked polymer covering at least part of the elastic body, the exposed area of the elastic body of the fine polymer particles (A) is reduced. Consequently, the elastic body is less likely to adhere to another elastic body, and therefore the dispersibility of the fine polymer particles (A) is improved.

In a case where the fine polymer particles (A) have the surface-crosslinked polymer, the following effects can be further brought about: (a) an effect of reducing the viscosity of the present resin composition; (b) an effect of increasing the crosslinking density of the elastic body; and (c) an effect of increasing the graft efficiency of the graft part. Note that the crosslinking density of the elastic body means a degree of the number of crosslinked structures in the entirety of the elastic body.

The surface-crosslinked polymer is constituted by a polymer containing, as structural units, (i) a structural unit derived from a polyfunctional monomer in an amount of 30% by weight to 100% by weight and (ii) a structural unit derived from any other vinyl-based monomer in an amount of 0% by weight to 70% by weight, which total 100% by weight.

Examples of the polyfunctional monomer which can be used to form the surface-crosslinked polymer by polymerization encompass the foregoing polyfunctional monomers. Out of such polyfunctional monomers, examples of a polyfunctional monomer which can be preferably used to form the surface-crosslinked polymer by polymerization encompass allyl methacrylate, ethylene glycol di(meth)acrylate, butanediol di(meth)acrylate, hexanediol di(meth)acrylate, cyclohexane dimethanol di(meth)acrylate, and polyethylene glycol di(meth)acrylates. The above-listed polyfunctional monomers may be used alone or in combination of two or more.

The fine polymer particles (A) may contain the surface-crosslinked polymer which is formed by polymerization independently of formation of the rubber-containing graft copolymer by polymerization, or may contain the surface-crosslinked polymer which is formed together with the rubber-containing graft copolymer by polymerization. The fine polymer particles (A) may be a multistage polymer obtained by forming the elastic body, the surface-crosslinked polymer, and the graft part in this order by multistage polymerization. In any of these aspects, the surface-crosslinked polymer can cover at least part of the elastic body.

The surface-crosslinked polymer can also be regarded as part of the elastic body. In a case where the fine polymer particles (A) contain the surface-crosslinked polymer, the graft part may (a) be grafted to the elastic body other than the surface-crosslinked polymer, (b) be grafted to the surface-crosslinked polymer, or (c) be grafted to both the elastic body other than the surface-crosslinked polymer and the surface-crosslinked polymer. In a case where the fine polymer particles (A) contain the surface-crosslinked polymer, the above-described volume-average particle size of the elastic body means the volume-average particle size of the elastic body including the surface-crosslinked polymer.

A case will be described where the fine polymer particles (A) is a multistage polymer obtained by forming the elastic body, the surface-crosslinked polymer, and the graft part in this order by multistage polymerization (case D). In the case D, the surface-crosslinked polymer can cover part of the elastic body or the whole of the elastic body. In the case D, part of the surface-crosslinked polymer may be located inside the elastic body. In the case D, the graft part can cover part of the surface-crosslinked polymer or the whole of the surface-crosslinked polymer. In the case D, part of the graft part may be located inside the surface-crosslinked polymer. In the case D, the elastic body, the surface-crosslinked polymer, and the graft part may have a layer structure. For example, aspects of one or more embodiments of the present invention also include an aspect such that the elastic body is present as the innermost layer (core layer), a layer of the surface-crosslinked polymer is present on the outer side of the elastic body as an intermediate layer, and a layer of the graft part is present on the outer side of the surface-crosslinked polymer as the outermost layer (shell layer).

(Volume-Average Particle Size (Mv) of Fine Polymer Particles (A))

The fine polymer particles (A) have a volume-average particle size (Mv) of preferably 0.03 μm to 50.00 μm, more preferably 0.05 μm to 10.00 μm, more preferably 0.08 μm to 2.00 μm, even more preferably 0.10 μm to 1.00 μm, still more preferably 0.10 μm to 0.80 μm, particularly preferably 0.10 μm to 0.50 μm because it is possible to obtain the resin composition which has a desired viscosity and which is highly stable. In a case where the volume-average particle size (Mv) of the fine polymer particles (A) falls within the above range, there is also an advantage that the dispersibility of the fine polymer particles (A) in a matrix resin is favorable. Note that, in the present specification, the “volume-average particle size (Mv) of the fine polymer particles (A)” means the volume-average particle size of the primary particles of the fine polymer particles (A) unless otherwise mentioned. The volume-average particle size of the fine polymer particles (A) can be measured with use of a dynamic light scattering type particle size distribution measurement apparatus using, as a test specimen, an aqueous latex containing the fine polymer particles (A). The volume-average particle size of the fine polymer particles (A) will be described in detail in Examples below. The volume-average particle size of the fine polymer particles (A) can also be measured by (i) cutting the cured product obtained from the resin composition, (ii) capturing an image of a cut surface with use of an electron microscope or the like, and (iii) using image data thus obtained (captured image).

The particle-number-based distribution of the particle size of the fine polymer particles (A) in a thermosetting resin preferably has a full width at half maximum which is not less than 0.5 times and not more than 1 time the volume-average particle size, because the resin composition which has a low viscosity and is easy to handle is obtained.

(1-7. Method of Producing Fine Polymer Particles (A) (Latex Producing Step))

In one or more embodiments of the present invention, the present production method may include a step of producing the fine polymer particles (A), particularly, a latex producing step of producing the latex containing the fine polymer particles (A), as a step prior to the resin mixing step. The latex means an aqueous latex.

For example, the fine polymer particles (A) can be produced as follows: after any polymer is formed by polymerization, the polymer which constitutes the graft part is grafted to the any polymer in the presence of the any polymer. The following description will discuss an example of a method of producing the fine polymer particles (A), while taking as an example a case where the elastic body is formed by polymerization and then the polymer which constitutes the graft part is grafted to the elastic body in the presence of the elastic body to produce the fine polymer particles (A).

The fine polymer particles (A) can be produced by a known method, for example, a method such as emulsion polymerization, suspension polymerization, or microsuspension polymerization. Specifically, the formation of the elastic body contained in the fine polymer particles (A), the formation of the graft part contained in the fine polymer particles (A) (graft polymerization), the formation of the surface-crosslinked polymer contained in the fine polymer particles (A) can be each achieved by a known method, for example, a method such as emulsion polymerization, suspension polymerization, or microsuspension polymerization. Out of these methods, emulsion polymerization may be the method of producing the fine polymer particles (A), because it facilitates (i) compositional design of the fine polymer particles (A), (ii) industrial production, and (iii) obtainment of the aqueous latex of the fine polymer particles (A) which can be suitably used to produce the present resin composition. A method of producing the elastic body which can be contained in the fine polymer particles (A), a method of producing the graft part which can be contained in the fine polymer particles (A), and a method of producing the surface-crosslinked polymer which can be optionally contained in the fine polymer particles (A) will be described below.

(Method of Producing Elastic Body)

A case will be considered where the elastic body includes at least one type of elastic body selected from the group consisting of diene-based rubbers and (meth)acrylate-based rubbers. In this case, the elastic body can be produced by, for example, a method such as emulsion polymerization, suspension polymerization, or microsuspension polymerization. As the method of producing the elastic body, a method disclosed in, for example, WO 2005/028546 can be used.

A case will be considered where the elastic body includes a polysiloxane rubber-based elastic body. In this case, the elastic body can be produced by, for example, a method such as emulsion polymerization, suspension polymerization, or microsuspension polymerization. As the method of producing the elastic body, a method disclosed in, for example, WO 2006/070664 can be used.

The method of producing the elastic body in a case where the elastic body is constituted by plural types of elastic bodies (for example, an elastic body₁, an elastic body₂, . . . , an elastic bodyₙ) will be described. In this case, the elastic body₁, the elastic body₂, . . . and the elastic bodyₙ are each formed individually by any of the above-described methods. Subsequently, these elastic bodies are mixed. In this manner, the elastic body which is constituted by the plural types of elastic bodies may be produced. Alternatively, the elastic body₁, the elastic body₂, . . . and the elastic bodyₙ may be formed in order by multistage polymerization to produce the elastic body which is constituted by the plural types of elastic bodies.

Formation of the elastic bodies by multistage polymerization will be described in detail. For example, (1) the elastic body₁ is formed by polymerization, (2) next, the elastic body₂ is formed by polymerization in the presence of the elastic body₁ to obtain a two-stage elastic body₁+2, (3) subsequently, an elastic body₃ is formed by polymerization in the presence of the elastic body₁₊₂ to obtain a three-stage elastic body₁₊₂₊₃, and (4) after a similar process(s) is/are carried out, the elastic bodyₙ is formed by polymerization in the presence of an elastic body_{1+2+ . . . +(n-1)} to obtain a multistage-polymerization elastic body_{1+2+ . . . +n}.

(Method of Producing Graft Part)

The graft part can be formed, for example, by polymerizing, by known radical polymerization, the monomer used to form the graft part. In a case where (a) the elastic body is obtained as an aqueous latex or (b) a fine polymer particle precursor containing the elastic body and the surface-crosslinked polymer is obtained as an aqueous latex, the graft part is preferably formed by emulsion polymerization. The graft part can be produced by a method disclosed in, for example, WO 2005/028546.

The method of producing the graft part in a case where the graft part is constituted by plural types of graft parts (for example, a graft part₁, a graft part₂, . . . , a graft partₙ) will be described. In this case, the graft part₁, the graft part₂, . . . and the graft partₙ are each formed individually by any of the above-described methods. Subsequently, these graft parts are mixed. In this manner, the graft part which is constituted by the plural types of graft parts may be produced. Alternatively, the graft part₁, the graft part₂, . . . the graft partₙ may be formed in order by multistage polymerization to produce the graft part which is constituted by the plural types of graft parts.

Formation of the graft parts by multistage polymerization will be described in detail. For example, (1) the graft part₁ is formed by polymerization, (2) next, the graft part₂ is formed by polymerization in the presence of the graft part₁ to obtain a two-stage graft part₁₊₂, (3) subsequently, a graft part₃ is formed by polymerization in the presence of the graft part₁₊₂ to obtain a three-stage graft part₁₊₂₊₃, and (4) after a similar process(s) is/are carried out, the graft partₙ is formed by polymerization in the presence of a graft part_{1+2+ . . . +(n-1)} to obtain a multistage-polymerization graft part_{1+2+ . . . +n}.

In a case where the graft part is constituted by the plural types of graft parts, the fine polymer particles (A) may be produced as follows: the graft part which is constituted by the plural types of graft parts is formed by polymerization, and then these graft parts are grafted to the elastic body. Alternatively, the fine polymer particles (A) may be produced as follows: in the presence of the elastic body, plural types of polymers which constitute the plural types of graft parts are formed in order by multistage graft polymerization with respect to the elastic body.

(Method of Producing Surface-Crosslinked Polymer)

The surface-crosslinked polymer can be formed by polymerizing, by known radical polymerization, the monomer used to form the surface-crosslinked polymer. In a case where the elastic body is obtained as an aqueous latex, the surface-crosslinked polymer is preferably formed by emulsion polymerization.

In a case where emulsion polymerization is employed as the method of producing the fine polymer particles (A), a known emulsifying agent (dispersion agent) can be used in the production of the fine polymer particles (A).

In a case where emulsion polymerization is employed as the method of producing the fine polymer particles (A), a pyrolytic initiator can be used in the production of the fine polymer particles (A). It is possible to use, as the pyrolytic initiator, a known initiator such as 2,2′-azobisisobutyronitrile, hydrogen peroxide, potassium persulfate, and/or ammonium persulfate, for example.

In the production of the fine polymer particles (A), a redox initiator can also be used. The redox initiator is an initiator which contains a combination of (a) a peroxide such as an organic peroxide and/or an inorganic peroxide and (b) as necessary a reducing agent such as sodium formaldehyde sulfoxylate and/or glucose, as necessary a transition metal salt such as iron (II) sulfate, as necessary a chelating agent such as disodium ethylenediaminetetraacetate, and/or as necessary a phosphorus-containing compound such as sodium pyrophosphate. Examples of the organic peroxide encompass t-butylperoxy isopropyl carbonate, paramenthane hydroperoxide, cumene hydroperoxide, dicumyl peroxide, t-butyl hydroperoxide, di-t-butyl peroxide, and t-hexyl peroxide. Examples of the inorganic peroxide encompass hydrogen peroxide, potassium persulfate, and ammonium persulfate.

Using the redox initiator makes it possible to (i) carry out polymerization even at a low temperature at which pyrolysis of the peroxide substantially does not occur and (ii) select a polymerization temperature from a wide range of temperatures. Thus, using the redox initiator is preferable. Out of redox initiators, organic peroxides such as cumene hydroperoxide, dicumyl peroxide, paramenthane hydroperoxide, and t-butyl hydroperoxide are more preferable for use as the redox initiator. The amount of the initiator used can be within a known range. In a case where the redox initiator is used, the amounts of, for example, the reducing agent used, the transition metal salt used, and the chelating agent used can be within known ranges.

In a case where, in the formation of the elastic body, the graft part, or the surface-crosslinked polymer by polymerization, a polyfunctional monomer is used to introduce a crosslinked structure into the elastic body, the graft part, or the surface-crosslinked polymer, a known chain transfer agent can be used in an amount within a known range. By using the chain transfer agent, it is possible to easily adjust the molecular weight and/or the degree of crosslinking of the resulting elastic body, graft part, or surface-crosslinked polymer.

In the production of the fine polymer particles (A), a surfactant can be further used, in addition to the above-described components. The type and the amount of the surfactant used are set within known ranges.

In the production of the fine polymer particles (A), conditions of polymerization such as polymerization temperature, pressure, and deoxygenation can be set within known ranges.

(1-8. Resin (B))

The resin (B) is not particularly limited in its properties, provided that the resin (B) is, at 25° C., a liquid having a viscosity of 100 mPa·s to 1,000,000 mPa·s, a semisolid, or a solid. Note that the wording “the resin (B) is, at 25° C., . . . having a viscosity of 100 mPa·s to 1,000,000 mPa·s” means that “the resin (B) which is at 25° C. has a viscosity of 100 mPa·s to 1,000,000 mPa·s”.

In a case where the resin (B) is a liquid, the viscosity of the resin (B) is preferably not more than 750,000 mPa·s, more preferably not more than 700,000 mPa·s, more preferably not more than 500,000 mPa·s, more preferably not more than 350,000 mPa·s, more preferably not more than 300,000 mPa·s, more preferably not more than 250,000 mPa·s, more preferably not more than 100,000 mPa·s, more preferably not more than 75,000 mPa·s, more preferably not more than 50,000 mPa·s, more preferably not more than 30,000 mPa·s, more preferably not more than 25,000 mPa·s, even more preferably not more than 20,000 mPa·s, and particularly preferably not more than 15,000 mPa·s, at 25° C. According to the above feature, the resin (B) has an advantage of having excellent flowability.

The viscosity of the resin (B) is more preferably not less than 200 mPa·s, more preferably not less than 300 mPa·s, more preferably not less than 400 mPa·s, more preferably not less than 500 mPa·s, even more preferably not less than 750 mPa·s, still more preferably not less than 1000 mPa·s, and particularly preferably not less than 1500 mPa·s, at 25° C. According to the above feature, the resin (B) is not impregnated into the fine polymer particles (A). Therefore, the resin (B) allows prevention of fusion between the fine polymer particles (A).

The viscosity of the resin (B) is more preferably 100 mPa·s to 750,000 mPa·s, more preferably 100 mPa·s to 700,000 mPa·s, more preferably 100 mPa·s to 350,000 mPa·s, more preferably 100 mPa·s to 300,000 mPa·s, more preferably 100 mPa·s to 50,000 mPa·s, even more preferably 100 mPa·s to 30,000 mPa·s, and particularly preferably 100 mPa·s to 15,000 mPa·s, at 25° C.

In a case where the resin (B) is a semisolid, it can be said that the resin (B) is a semiliquid, and it can be said that the resin (B) has a viscosity of more than 1,000,000 mPa·s. In a case where the resin (B) is a semisolid or a solid, the resin composition which contains the resulting powdery and/or granular material has an advantage of being less sticky and easy to handle.

The viscosity of the resin (B) can be measured by a viscometer. A method of measuring the viscosity of the resin (B) will be described in detail in Examples below.

Further, the viscosity of the resin (B) is more preferably not less than 100 mPa·s, even more preferably not less than 500 mPa·s, still more preferably not less than 1000 mPa·s, and particularly preferably not less than 1500 mPa·s, at 25° C., because such a viscosity allows the resin (B) to get between the fine polymer particles (A) and thereby allows prevention of fusion between the fine polymer particles (A).

Further, in a case where a matrix resin is a thermosetting resin, the viscosity of the resin (B) at 25° C. is preferably equal to or lower than a value obtained by adding 50000 mPa·s to the viscosity of such a thermosetting matrix resin at 25° C. In view of facilitating uniform mixing of the resin (B) and the thermosetting matrix resin, in a case where the viscosity of the resin (B) at 25° C. is equal to or higher than the viscosity of the thermosetting matrix resin at 25° C., the viscosity of the resin (B) at 25° C. is more preferably equal to or lower than a value obtained by adding 20000 mPa·s to the viscosity of the thermosetting matrix resin at 25° C., more preferably equal to or lower than a value obtained by adding 10000 mPa·s to the viscosity of the thermosetting matrix resin at 25° C., even more preferably equal to or lower than a value obtained by adding 5000 mPa·s to the viscosity of the thermosetting matrix resin at 25° C., and most preferably equal to or lower than a value obtained by adding 0 mPa·s to the viscosity of the thermosetting matrix resin at 25° C.

The resin (B) has an endothermic peak at preferably not higher than 25° C., more preferably not higher than 0° C., in its differential scanning calorimetry (DSC) thermogram.

The resin (B) may be identical to or different from a thermosetting resin which is a matrix resin (described later) with which the resin composition that is the agglutinate containing the fine polymer particles (A) and the resin (B) is mixed. As an example, a case will be considered where the resin (B) is used in the method of producing a resin composition and the resin (B) is of the same type as that of a thermosetting resin which is a matrix resin. In this case, the obtained resin composition appears to have merely the matrix resin in addition to the fine polymer particles (A), because it is not possible to distinguish between the matrix resin and the resin (B) in the obtained resin composition. Next, a case will be considered where the resin (B) is used in the method of producing a resin composition and the resin (B) is of a type different from that of a matrix resin. In this case, it is possible to distinguish between the matrix resin and the resin (B) in the obtained resin composition. In this case, the ultimately obtained resin composition can contain the resin (B) as a resin other than the matrix resin, in addition to the fine polymer particles (A).

The resin (B) can be, for example, a thermosetting resin, a thermoplastic resin, or any combination of a thermosetting resin and a thermoplastic resin. In a case where the present resin composition contains the resin (B), the resin (B) can have an effect of enhancing the dispersibility of the fine polymer particles (A) in a thermosetting resin.

Examples of the thermosetting resin which is the resin (B) encompass various thermosetting resins described later in the section of a matrix resin. As the resin (B), the thermosetting resins may be used alone or in combination of two or more.

Examples of the thermoplastic resin which is the resin (B) encompass polymers each containing, as one or more structural units, one or more structural units derived from at least one type of monomer selected from the group consisting of aromatic vinyl monomers, vinyl cyanide monomers, and (meth)acrylate monomers. As the resin (B), the thermoplastic resins may be used alone or in combination of two or more.

In a case where a matrix resin with which the resin composition that is the agglutinate containing the fine polymer particles (A) and the resin (B) is mixed is a thermosetting resin, the resin (B) is preferably of the same type as that of the thermosetting resin which is the matrix resin, because such a resin (B) is less likely to affect various physical properties. That is, in a case where a thermosetting resin which is a matrix resin is an epoxy resin, the resin (B) may be also an epoxy resin. In a case where the resin (B) is different from a thermosetting resin which is a matrix resin, the resin (B) is preferably compatible with the thermosetting resin which is the matrix resin.

In a case where the total amount of the fine polymer particles (A) and the resin (B) is regarded as 100% by weight, the amount of the fine polymer particles (A) may be 1% by weight to 70% by weight and the amount of the resin (B) be 30% by weight to 99% by weight. The above ranges make it possible to, while maintaining the characteristics (heat resistance, rigidity, and the like) of a thermosetting resin in a liquid state, improve the fracture toughness, the adhesion strength, the surface impact resistance, and the like. Note that the above ranges intend the ratio between the fine polymer particles (A) and the resin (B) in the agglutinate (the resin composition) obtained by the method of producing a resin composition.

From the viewpoint of the viscosity, the amount of the fine polymer particles (A) may be 10% by weight to 60% by weight and the amount of the resin (B) be 90% by weight to 40% by weight, the amount of the fine polymer particles (A) may be 20% by weight to 50% by weight and the amount of the resin (B) be 80% by weight to 50% by weight, or the amount of the fine polymer particles (A) may be 25% by weight to 45% by weight and the amount of the resin (B) be 75% by weight to 55% by weight.

(Others)

In the present specification, fats and oils as well as fatty acid esters are also included in the resin (B). Examples of the fats and oils which can be suitably used as the resin (B) encompass epoxidized fats and oils such as epoxidized soybean oil and epoxidized linseed oil. Commercially available epoxidized soybean oil can also be used, and examples thereof encompass ADK CIZER O-130P manufactured by ADEKA Co., Ltd. Examples of the fatty acid esters which can be suitably used as the resin (B) encompass epoxidized fatty acid esters such as epoxidized fatty acid butyl, epoxidized fatty acid 2-ethylhexyl, epoxidized fatty acid octyl ester, and epoxidized fatty acid alkyl ester.

The epoxidized fats and oils and the epoxidized fatty acid esters are sometimes referred to as epoxy-based plasticizers. That is, in the present specification, epoxy-based plasticizers are also included in the resin (B). Examples of the epoxy-based plasticizers, other than the epoxidized fats and oils and the epoxidized fatty acid esters, encompass diepoxystearyl epoxyhexahydrophthalate and epoxyhexahydro Di(2-ethylhexyl)phthalate.

The above-described thermosetting resins, thermoplastic resins, mixtures of the thermosetting resins and the thermoplastic resins, fats and oils, and fatty acid esters can be each used in admixture with an antioxidant. In the present specification, the antioxidant is regarded as part of the resin (B), as long as the antioxidant is used in admixture with each of the above-described substances. In a case where only the antioxidant is used, the antioxidant is not regarded as the resin (B).

The antioxidant is not limited to any particular one. Examples of the antioxidant encompass (a) primary antioxidants such as phenol-based antioxidants, amine-based antioxidants, lactone-based antioxidants, and hydroxylamine-based antioxidants and (b) secondary antioxidants such as sulfur-based antioxidants and phosphorus-based antioxidants.

Examples of the phenol-based antioxidants encompass hindered phenol-based antioxidants. Examples of the hindered phenol-based antioxidants encompass a compound having a hindered phenol structure or a semi-hindered phenol structure in its molecule. Commercially available phenol-based antioxidants can also be used, and examples thereof encompass Irganox 245 (manufactured by BASF Japan Ltd.).

The amine-based antioxidants are not limited to any particular ones, and a wide range of conventionally known amine-based antioxidants can be used. Specific examples of the amine-based antioxidants encompass amine-ketone-based compounds such as a 2,2,4-trimethyl-1,2-dihydroquinoline polymer, 6-ethoxy-1,2-dihydro-2,2,4-trimethylquinoline, and a reaction product of diphenylamine and acetone.

The amine-based antioxidants also encompass aromatic amine compounds. Examples of the aromatic amine compounds encompass naphthylamine-based antioxidants, diphenylamine-based antioxidants, and p-phenylenediamine-based antioxidants.

The lactone-based antioxidants, the hydroxylamine-based antioxidants, and the sulfur-based antioxidants are not limited to any particular ones. A wide range of conventionally known lactone-based antioxidants, hydroxylamine-based antioxidants, and sulfur-based antioxidants can be used.

The phosphorus-based antioxidants are not limited to any particular ones, and a wide range of conventionally known phosphorus-based antioxidants can be used. Phosphoric acid and phosphoric ester, each of which contains active hydrogen, can adversely affect the storage stability of the resulting resin composition which contains the powdery and/or granular material, and can adversely affect the heat resistance of the cured product or the molded product provided by the resin composition. Therefore, as the phosphorus-based antioxidants, alkyl phosphite, aryl phosphite, alkyl aryl phosphite compounds, and the like which do not contain phosphoric acid or phosphoric ester in their molecules are preferable.

Alternatively, the antioxidant can be any other conventionally known substance. Examples of such an antioxidant encompass various substances described in, for example, “Sanka Boshizai Handobukku (Antioxidant Handbook)” published by Taiseisha (the date of publication of the first edition: Oct. 25, 1976), “Kobunshitenkazai handobukku (Polymeric additive Handbook)” published by CMC Publishing Co., Ltd. (the author and editor: HARUNA, Toru, the date of publication of the first edition: Nov. 7, 2010), and the like.

The resin (B) is preferably at least one selected from the group consisting of the thermosetting resins, mixtures of the thermosetting resins and the antioxidants, the thermoplastic resins, mixtures of the thermoplastic resins and the antioxidants, the fats and oils, mixtures of the fats and oils and the antioxidants, the fatty acid esters, mixtures of the fatty acid esters and the antioxidants, epoxy curing agents, and mixtures of the epoxy curing agents and the antioxidants, more preferably at least one selected from the group consisting of epoxy resins, acrylic polymers, mixtures of the epoxy resins and the antioxidants, mixtures of the acrylic polymers and the antioxidants, and mixtures of the epoxy-based plasticizers and the antioxidants, still more preferably at least one selected from the group consisting of the mixtures of the epoxy resins and the antioxidants, the mixtures of the acrylic polymers and the antioxidants, and the mixtures of the epoxy-based plasticizers and the antioxidants, and particularly preferably any of the mixtures of the epoxy-based plasticizers and the antioxidants. According to the above feature, the resulting resin composition which contains the powdery and/or granular material has advantages that (a) it is possible to provide the cured product or the molded product each of which has excellent heat resistance and (b) it is possible to improve the dispersibility of the fine polymer particles (A) in a matrix resin.

[2. Method of Producing Resin Composition (Embodiment 2 Involving a Freezing Step)]

A method of producing a resin composition in accordance with other embodiments of the present invention includes: a resin mixing step of mixing, into a latex containing fine polymer particles (A), a resin (B) having a viscosity of not more than 1,000,000 mPa·s at 25° C.; a freezing step of freezing the latex which has been obtained in the resin mixing step and in which the resin (B) is dispersed; a thawing step of thawing the latex which has been frozen in the freezing step; and after the thawing step, a separating step of separating the latex into a resin composition and a water component, the resin composition being an agglutinate containing the fine polymer particles (A) and the resin (B).

The inventors of one or more embodiments of the present invention found that, by mixing (i) the latex containing the fine polymer particles (A) and (ii) the resin (B) and then freezing the resulting latex, water in the latex is frozen, thereby the fine polymer particles (A) and the resin (B) are concentrated, and consequently the water and the agglutinate containing the fine polymer particles (A) and the resin (B) are separated. By dispersion of the resin (B) in the latex containing the fine polymer particles (A), the resin (B) gets between the fine polymer particles (A). Thereafter, by freezing this latex, it is possible to prevent agglutination of the fine polymer particles (A), even in a case where a freezing rate is slow. This ultimately allows obtainment of the agglutinate in which the fine polymer particles (A) are uniformly dispersed in the resin (B). Note that, in a case of the present production method in which the fine polymer particles (A) and the resin (B) are mixed and then frozen, the freezing rate may be slow or fast.

According to the present production method, since a salt (such as a flocculant) and an organic solvent are not used, it is possible to obtain the agglutinate which imposes a reduced environmental load and which contains few contaminants (few impurities), similarly to the above-described production method. Since the freezing step is carried out, the fine polymer particles (A) are collected with good efficiency. Furthermore, it is possible to reduce inclusion of an emulsifying agent in the agglutinate, and therefore possible to obtain the agglutinate which contains few emulsifying agent-derived substances (impurities).

The following description will discuss the steps relating to Embodiment 2. For matters other than those detailed below, the description of Embodiment 1 will apply as appropriate.

(2-1. Resin Mixing Step)

The resin mixing step is a step of mixing, into the latex containing the fine polymer particles (A), the resin (B) having a viscosity of not more than 1,000,000 mPa·s at 25° C. It can be said that this step is a step of (i) adding the resin (B) to the latex containing the fine polymer particles (A) and (ii) mixing the resulting latex to disperse the resin (B) in the latex. The resin mixing step is similar to that in Embodiment 1, except that before the freezing step, the resin mixing step is carried out so that the resin (B) is dispersed in the latex.

In the resin mixing step, the resin (B) may be mixed with the latex, as an emulsified product (also referred to as emulsified liquid or aqueous emulsion) obtained by dispersing the resin (B) in water in advance. This makes it possible to uniformly disperse the resin (B) in the latex containing the fine polymer particles (A), and possible to, by carrying out the freezing step and subsequent steps (described later), obtain the agglutinate in which the fine polymer particles (A) and the resin (B) are more uniformly dispersed.

(2-2. Freezing Step)

The freezing step is a step of freezing the latex which has been obtained in the resin mixing step and in which the resin (B) is dispersed. This step is a step of freezing the latex to agglutinate the fine polymer particles (A) and the resin (B).

Note, here, that the wording “freezing” includes a step of rapidly freezing the latex and a step of slowly freezing the latex. A method of rapidly freezing the latex is similar to that in Embodiment 1. Note also that the wording “slowly freezing” means freezing the latex in 20 minutes to 24 hours. The latex is frozen in more preferably 30 minutes to 12 hours, and even more preferably 1 hour to 10 hours. Examples of a method in which a freezing rate is slow encompass: a method in which the latex is frozen in a freezer at −10° C. to −80° C.; and a method in which the latex is frozen in a tunnel/spiral freezer.

(2-3. Thawing Step)

The thawing step is a step of thawing the latex which has been frozen in the freezing step. A specific method of thawing the latex is similar to that in Embodiment 1.

(2-4. Separating Step)

The separating step is a step of separating the latex into the resin composition, which is the agglutinate containing the fine polymer particles (A) and the resin (B), and the water component, after the thawing step. The separating step can be referred to as a step of removing water in the latex which water has been generated in the thawing step, so as to obtain the resin composition which is the agglutinate containing the fine polymer particles (A) and the resin (B). A specific method of separating the latex into the resin composition and the water component is similar to that in Embodiment 1.

The present production method preferably further includes a washing step of washing the resin composition. By washing the obtained resin composition, which is the agglutinate, with water, the agglutinate which contains few water-soluble compounds (contaminants) is obtained. The details of the washing step are similar to those of the washing step in Embodiment 1.

(2-5. Removing Step)

The present production method preferably further includes, before the freezing step, a removing step of removing the agglutinate which has been generated in the resin mixing step. In the resin mixing step, there is a case where an aggregate is generated in the latex. In this case, the freezing step is preferably carried out after the resin composition which has agglutinated is once removed. This is because, according to the agglutinate generated in the resin mixing step, even in a case where the latex is subsequently frozen, the fine polymer particles (A) do not agglutinate. This makes it possible to efficiently agglutinate the fine polymer particles (A) and the resin (B) in the freezing step and collect them.

[3. Method of Producing Resin Composition (Embodiment 3 Involving Shearing Step)]

A method of producing a resin composition in accordance with other embodiments of the present invention includes: a resin mixing step of mixing, into a latex containing fine polymer particles (A), a resin (B) having a viscosity of not more than 1,000,000 mPa·s at 25° C.; a shearing step of applying shearing stress to the latex which has been obtained in the resin mixing step; and after the shearing step, a first separating step of separating the latex into a resin composition and a water component, the resin composition being an agglutinate containing the fine polymer particles (A) and the resin (B).

The inventors of one or more embodiments of the present invention found that, by mixing (i) the latex containing the fine polymer particles (A) and (ii) the resin (B) and then applying shearing stress to the resulting mixed latex, an effect of emulsifying the latex is reduced, thus the agglutinate in which the fine polymer particles (A) in the latex agglutinate in a state of being dispersed in the resin (B) is obtained, and water in the latex is separated.

According to the present production method, since an organic solvent and a salt such as a flocculant are not used, it is possible to obtain the agglutinate which imposes a reduced environmental load and which contains few contaminants. Furthermore, since it is possible to separate the latex into the agglutinate and water by applying shearing stress, it is possible to obtain the agglutinate which hardly contains an emulsifying agent.

The following description will discuss the steps relating to Embodiment 3. For matters other than those detailed below, the description of Embodiments 1 and 2 will apply as appropriate.

(3-1. Resin Mixing Step)

The resin mixing step is a step of mixing, into the latex containing the fine polymer particles (A), the resin (B) having a viscosity of not more than 1,000,000 mPa·s at 25° C. This step is similar to those in Embodiments 1 and 2.

In the production method in accordance with Embodiment 3, from the viewpoint that the agglutinate can be easily made by the shearing step (described later), the solid content concentration (total concentration of the fine polymer particles (A) and the resin (B)) of the latex is set to preferably not less than 1%, more preferably not less than 3%, and even more preferably not less than 5%.

(3-2. Shearing Step)

The shearing step is a step of applying shearing stress to the latex which has been obtained in the resin mixing step. This step is a step of applying shearing stress to the latex (liquid mixture of the fine polymer particles (A) and the resin (B)) which has been obtained in the resin mixing step, so as to agglutinate the fine polymer particles (A) and the resin (B).

A method of applying shearing stress to the latex is not limited to any particular one, and various techniques can be employed. Examples thereof encompass: stirring the latex at 3000 rpm to 25000 rpm with use of a homomixer; stirring the latex at 500 rpm to 12000 rpm with use of a high shearing emulsifier; and using a high pressure homogenizer. In a case where a homomixer is used, the latex is stirred at preferably 5000 rpm to 25000 rpm, preferably 7000 rpm to 20000 rpm, and more preferably 8000 rpm to 20000 rpm, from the viewpoint of an agglutinating rate. In a case where the latex is stirred with use of a high shearing emulsifier, the latex is stirred at preferably 1000 rpm to 12000 rpm, preferably 2000 rpm to 20000 rpm, and more preferably 2500 rpm to 20000 rpm.

Modes of this step include a mode in which, at a stage prior to the resin mixing step, shearing stress is applied, in advance, to the latex which contains the fine polymer particles (A) and which has not been mixed with the resin (B). Moreover, the modes of this step also include a mode in which shearing stress is applied to the resin (B) in advance. The modes of this step may further include a mode in which shearing stress is applied to both (i) the latex containing the fine polymer particles (A) and (ii) the resin (B) in advance before the resin mixing step. These methods are preferable in that the emulsifying ability of the latex is reduced and accordingly the agglutinate is efficiently obtained.

In a case where the viscosity of the resin (B) is high, the viscosity of the resin (B) is preferably adjusted to an optimum viscosity. The optimum viscosity is, for example, more preferably 100 mPa·s to 750,000 mPa·s, more preferably 150 mPa·s to 700,000 mPa·s, more preferably 200 mPa·s to 350,000 mPa·s, more preferably 250 mPa·s to 300,000 mPa·s, more preferably 300 mPa·s to 50,000 mPa·s, even more preferably 350 mPa·s to 30,000 mPa·s, and particularly preferably 400 mPa·s to 15,000 mPa·s. A method of adjusting the viscosity is not limited to any particular one, and examples thereof encompass a method in which a temperature is adjusted. By setting the viscosity of the resin (B) to an optimum value, it is possible to prevent pressure during transfer from becoming excessively high, possible to efficiently carry out the shearing step, and possible to efficiently obtain the agglutinate.

The shearing step is preferably carried out in the presence of a gas-liquid interface. According to the above feature, it is possible to efficiently agglutinate the fine polymer particles (A) and the resin (B). In order to carry out the shearing step in the presence of an gas-liquid interface, it is only necessary that air bubbles (also referred to as air or bubbles) are present in the latex which has been obtained in the resin mixing step. In other words, the shearing step is preferably carried out while the latex which has been obtained in the resin mixing step and gas (for example, air, carbon dioxide, and nitrogen) are mixed.

The temperature of the latex in the shearing step is not limited to any particular one. For example, from the viewpoint of deterioration of the fine polymer particles (A), the temperature is preferably 10° C. to 90° C., more preferably 15° C. to 80° C., and even more preferably 20° C. to 70° C.

The shearing step can be carried out in various modes, which are not limited to any particular ones. Examples of the modes encompass: (i) a mode in which the shearing step is carried out in a batch manner by providing a shearing means (emulsifier or the like) to a container in which the latex which has been obtained in the resin mixing step is introduced; (ii) a mode in which a step of causing the latex to pass through a shearing means (emulsifier or the like) is carried out a plurality of times, (iii) a mode in which the resin mixing step and the shearing step are consecutively carried out (a step of applying shearing stress to the latex which has been obtained in the resin mixing step, by providing a shearing means (emulsifier or the like) to a flow path into which a flow path through which the latex passes and a flow path through which the resin (B) passes are merged); (iv) a mode in which, in the mode (iii), the latex is subjected to the shearing means (emulsifier or the like) a plurality of times; and (v) a mode in which the latex which has been subjected to the shearing means (emulsifier or the like) in the mode (iii) or (iv) is separated into the agglutinate and water and then an operation in the mode (iii) or (iv) is carried out so that shearing stress is applied a plurality of times.

(3-3. First Separating Step)

The first separating step is a step of separating the latex into the resin composition, which is the agglutinate containing the fine polymer particles (A) and the resin (B), and the water component, after the shearing step. The first separating step can be referred to as a step of removing water in the latex which water has been generated by shearing and agglutination, so as to obtain a first agglutinate containing the fine polymer particles (A) and the resin (B). The details of the separating step are similar to those of the separating step in Embodiment 1.

(3-4. Agglutinating Step and Second Separating Step)

The present production method preferably further includes: an agglutinating step of agglutinating the fine polymer particles (A) and the resin (B) contained in the water component from which the agglutinate has been separated in the first separating step, so as to obtain the resin composition which is the agglutinate containing the fine polymer particles (A) and the resin (B); and after the agglutinating step, a second separating step of separating the resin composition, which is the agglutinate containing the fine polymer particles (A) and the resin (B), and the water component. These steps are steps of (i) again agglutinating the fine polymer particles (A) and the resin (B) which have not been collected in the above-described steps and (ii) collecting the agglutinate containing the fine polymer particles (A) and the resin (B).

These steps allow collection of the fine polymer particles (A) which have not agglutinated, and ultimately allow an improvement in productivity. Moreover, these steps allow a decrease in COD (chemical oxygen demand), and allows a reduction in effluent load.

The agglutinate which has been obtained in the second separating step may be mixed with the agglutinate which has been obtained in the first separating step, and thereby the resin composition may be formed.

In the agglutinating step, a specific method of agglutinating the fine polymer particles (A) and the resin (B) is not limited to any particular one, and examples thereof encompass: a method in which a flocculant is used; and a method in which the latex is frozen.

The flocculant which can be used is not limited to any particular one, provided that the flocculant is a polymer agglutinant and/or an aqueous solution of an inorganic acid (salt) and/or an organic acid (salt) that has the property of allowing an emulsion polymerization latex to coagulate or flocculate. Examples of the aqueous solution encompass: aqueous solution of one or more mineral salts such as sodium chloride, potassium chloride, lithium chloride, sodium bromide, potassium bromide, lithium bromide, potassium iodide, sodium iodide, potassium sulfate, sodium sulfate, ammonium sulfate, ammonium chloride, sodium nitrate, potassium nitrate, calcium chloride, ferrous sulfate, magnesium sulfate, zinc sulfate, copper sulfate, barium chloride, ferrous chloride, ferric chloride, magnesium chloride, ferric sulfate, aluminum sulfate, potassium alum, and/or iron alum; aqueous solution of one or more inorganic acids such as hydrochloric acid, sulfuric acid, nitric acid, and/or phosphoric acid; organic acids such as acetic acid and formic acid and aqueous solution of one or more of them; and aqueous solution of one or more organic acid salts such as sodium acetate, calcium acetate, sodium formate, and/or calcium formate. The polymer agglutinant is not limited to any particular one, provided that the polymer agglutinant is a polymer compound containing a hydrophilic group and a hydrophobic group, and may be any one or more of the following: an anionic polymer agglutinant, a cationic polymer agglutinant, and a nonionic polymer agglutinant. The polymer agglutinant is preferably a cationic polymer agglutinant, because this makes it possible to further improve an effect of one or more embodiments of the present invention. The cationic polymer agglutinant may be a polymer agglutinant that contains a cationic group within its molecule, that is, a polymer agglutinant that shows a cationic property when dissolved in water. Examples of such a polymer agglutinant encompass polyamines, polydicyandiamides, cationized starch, cationic poly(meth)acrylamide, water-soluble aniline resin, polythiourea, polyethyleneimine, quaternary ammonium salts, polyvinylpyridines, and chitosan. One of such compounds may be used alone or in combination of two or more. Out of the above flocculants, suitably used is an aqueous solution of one or more mono- or di-valent mineral salts or mono- or di-valent inorganic acids such as sodium chloride, potassium chloride, sodium sulfate, ammonium chloride, calcium chloride, magnesium chloride, magnesium sulfate, barium chloride, hydrochloric acid, and/or sulfuric acid. A method of adding the flocculant is not limited to any particular one. The flocculant may be added at a time, added batchwise, or added continuously.

The amount of the flocculant to be added can be 1 part by weight to 50 parts by weight with respect to 100 parts by weight of the resin composition. The amount of the flocculant is preferably 2 parts by weight to 30 parts by weight, and more preferably 3 parts by weight to 20 parts by weight. Note that the amount of the flocculant to be added can be varied, as appropriate, depending on the type of the latex.

In particular, the agglutinating step preferably includes a freezing step of freezing the water component from which the agglutinate has been separated in the first separating step. According to the freezing step, by freezing the resin (B) and the water component (latex) from which the agglutinate has been separated in the first separating step, water in the latex is frozen. This causes the fine polymer particles (A) and the resin (B) to be concentrated so that the fine polymer particles (A) and the resin (B) forms the agglutinate. Consequently, the water and the agglutinate are separated. Obtaining the agglutinate by the freezing step obviates the need to use a flocculant or the like. Therefore, the agglutinate which contains few contaminants is obtained. The details of the freezing step are similar to those of the rapid freezing step in Embodiment 1 and those of the freezing step in Embodiment 2. The details of the second separating step are similar to those of the separating step in Embodiment 1.

The present production method preferably further includes a washing step of washing the resin composition. By washing the obtained resin composition, which is the agglutinate, with water, the agglutinate which contains few water-soluble compounds (contaminants) is obtained. The details of the washing step are similar to those of the washing step in Embodiment 1.

[4. Resin Composition]

A resin composition in accordance with one or more embodiments of the present invention is a resin composition containing: fine polymer particles (A) which have a graft part that is constituted by a polymer containing, as one or more structural units, one or more structural units derived from at least one type of monomer selected from the group consisting of aromatic vinyl monomers, vinyl cyanide monomers, and (meth)acrylate monomers; and a resin (B) which has a viscosity of not more than 1,000,000 mPa·s at 25° C., in a case where a total amount of the fine polymer particles (A) and the resin (B) is regarded as 100% by weight, an amount of the fine polymer particles (A) being 1% by weight to 70% by weight and an amount of the resin (B) being 30% by weight to 99% by weight, in a case where an amount of the fine polymer particles (A) contained in the resin (B) is 5% by weight, dispersibility of the fine polymer particles (A) in the resin (B) being not more than 0 μm when evaluated in accordance with JIS K5101 with use of a grind gauge, the resin composition substantially not containing an organic solvent, the resin composition containing sulfur (S) and phosphorus (P) each in an amount of not more than 150 ppm, the resin composition having an electric conductivity of not more than 0.6 mS/cm. Hereinafter, the resin composition may be simply referred to as the present resin composition.

Further, the present resin composition may contain calcium (Ca), magnesium (Mg), iron (Fe), zinc (Zn), barium (Ba), and aluminum (Al), each in an amount of not more than 100 ppm.

The present resin composition hardly contains an organic solvent. Therefore, the present resin composition imposes a reduced environmental load, and also less adversely affects human bodies. That the resin composition has an electric conductivity of not more than 0.6 mS/cm means that the ion content of the resin composition is low. That the ion content of the resin composition is low means that the resin composition contains few impurities and/or contaminants (water-soluble compounds) which are derived from an emulsifying agent, a flocculant (mineral salt), and/or metallic soap. Therefore, the present resin composition is suitable for use in electronic materials and the like. This is because corrosion, insulation failure, and/or migration of substrate wiring and/or a lead of an element is/are caused depending on the ion content. The present resin composition can be obtained by, for example, the method of producing a resin composition as has been described.

(4-1. Dispersibility)

The present resin composition is preferably arranged such that, in a case where the amount of the fine polymer particles (A) contained in the resin (B) is 5% by weight, the dispersibility of the fine polymer particles (A) in the resin (B) is not more than 0 μm when evaluated in accordance with JIS K5101 with use of a grind gauge. According to the present resin composition, the fine polymer particles (A) are uniformly dispersed in the resin (B). Thus, in a case where the present resin composition is mixed with a matrix resin, the fine polymer particles (A) can be well dispersed in the matrix resin. A specific method of evaluating the dispersibility will be described in detail in Examples below.

(4-2. Organic Solvent)

The present resin composition substantially does not contain an organic solvent. The wording “substantially does not contain an organic solvent” means that the resin composition contains an organic solvent in an amount of not more than 100 ppm.

The amount of the organic solvent contained in the present resin composition (also referred to as a solvent content) is preferably not more than 100 ppm, more preferably not more than 50 ppm, even more preferably not more than 25 ppm, and particularly preferably not more than 10 ppm. It can also be said that the amount of the organic solvent contained in the present resin composition is the amount of a volatile component (other than water) contained in the present resin composition. The amount of the organic solvent (volatile component) contained in the present resin composition can be determined, for example, as follows. That is, a given amount of the resin composition is heated with use of a hot air dryer or the like, the weight of the resin composition is measured before and after heating, and the amount of decrease in weight is regarded as the amount of the organic solvent. Alternatively, the amount of the organic solvent (volatile component) contained in the present resin composition can also be determined by gas chromatography. In a case where an organic solvent is not used in production of the present resin composition and a powdery and/or granular material contained in the resin composition, the amount of the organic solvent contained in the obtained resin composition can be regarded as 0 ppm.

Examples of the organic solvent which is substantially not contained in the present resin composition encompass (a) esters such as methyl acetate, ethyl acetate, propyl acetate, and butyl acetate, (b) ketones such as acetone, methyl ethyl ketone, diethyl ketone, and methyl isobutyl ketone, (c) alcohols such as ethanol, (iso)propanol, and butanol, (d) ethers such as tetrahydrofuran, tetrahydropyran, dioxane, and diethyl ether, (e) aromatic hydrocarbons such as benzene, toluene, and xylene, and (f) halogenated hydrocarbons such as methylene chloride and chloroform.

(4-3. Amounts of S Etc.)

The present resin composition contains S and P each in an amount of not more than 150 ppm. Further, the present resin composition may contain Ca, Mg, Fe, Zn, Ba, and Al each in an amount of not more than 100 ppm. The amounts of the above chemical elements contained in the present resin composition are each preferably not more than 100 ppm, more preferably not more than 60 ppm, even more preferably not more than 25 ppm, and particularly preferably not more than 10 ppm.

(4-4. Electric Conductivity)

The present resin composition has an electric conductivity of not more than 0.6 mS/cm. The electric conductivity is more preferably not more than 0.5 mS/cm, even more preferably not more than 0.3 mS/cm, and particularly preferably not more than 0.15 mS/cm. Note that the amount of sodium (Na) which is contained as an impurity can be grasped by the electric conductivity, because metallic soap derived from Na⁺ easily dissolves in water. For example, in a case where the resin composition contains Na in a large amount, Na⁺ is present in a large amount. This results in a high electric conductivity. Therefore, it is considered that in a case where the electric conductivity is lower than the above given value, the resin composition contains Na in a small amount.

In the present specification, the “electrical conductivity” refers to the electric conductivity of water which is obtained by mixing the resin composition with the same amount of ion exchanged water at 90° C. for 30 minutes and then carrying out separation. A specific method of measuring the electrical conductivity will be described in detail in Examples below.

(4-5. Fine Polymer Particles (A) and Resin (B))

The fine polymer particles (A) and the resin (B) are similar to those described in Embodiment 1 (method of producing a resin composition), and the description of Embodiment 1 can apply. In particular, the fine polymer particles (A) are preferably constituted by a rubber-containing graft copolymer which has an elastic body and a graft part grafted to the elastic body. The elastic body preferably includes at least one type of elastic body selected from the group consisting of diene-based rubbers, (meth)acrylate-based rubbers, and polysiloxane rubber-based elastic bodies.

The resin (B) is preferably a thermosetting resin. In particular, the thermosetting resin is preferably at least one type of thermosetting resin selected from the group consisting of: ethylenically unsaturated monomers; epoxy resins; phenolic resins; polyol resins; and amino-formaldehyde resins (melamine resins).

According to the above feature, while the characteristics (heat resistance, rigidity, and the like) of a liquid thermosetting resin are maintained, the fracture toughness, the adhesion strength, the surface impact resistance, and the like can be improved.

[5. Resin Composition (Mixture of Present Resin Composition and Matrix Resin)]

One or more embodiments of the present invention can also include a resin composition obtained by mixing the above-described resin composition and a matrix resin. In other words, the present resin composition contains the above-described resin composition and a matrix resin.

(5-1. Matrix Resin)

As the matrix resin, a thermosetting resin can be suitably used. The thermosetting resin preferably includes at least one type of thermosetting resin selected from the group consisting of: resins each containing a polymer obtained by polymerization of an ethylenically unsaturated monomer; epoxy resins; phenolic resins; polyol resins; and amino-formaldehyde resins (melamine resins). Examples of the thermosetting resin also encompass resins each containing a polymer obtained by polymerization of an aromatic polyester raw material. Examples of the aromatic polyester raw material encompass: radical-polymerizable monomers such as aromatic vinyl compounds, (meth)acrylic acid derivatives, vinyl cyanide compounds, and maleimide compounds; dimethyl terephthalate; and alkylene glycol. These thermosetting resins may be used alone or in combination of two or more.

(Ethylenically Unsaturated Monomer)

The ethylenically unsaturated monomer is not limited to any particular one, provided that the ethylenically unsaturated monomer has at least one ethylenically unsaturated bond in its molecule.

Examples of the ethylenically unsaturated monomer encompass acrylic acid, α-alkyl acrylic acids, α-alkyl acrylic acid esters, β-alkyl acrylic acids, β-alkyl acrylic acid esters, methacrylic acid, esters of acrylic acid, esters of methacrylic acid, vinyl acetate, vinyl esters, unsaturated esters, polyunsaturated carboxylic acids, polyunsaturated esters, maleic acid, maleic acid esters, maleic anhydride, and acetoxy styrene. These ethylenically unsaturated monomers may be used alone or in combinations of two or more.

(Epoxy Resins)

The epoxy resins are not limited to any particular ones, provided that the epoxy resins each have at least one epoxy bond in its molecule.

Specific examples of the epoxy resins encompass bisphenol A epoxy resin, bisphenol F epoxy resin, bisphenol AD epoxy resin, bisphenol S epoxy resin, glycidyl ester type epoxy resin, glycidyl amine type epoxy resin, novolac type epoxy resin, glycidyl ether epoxy resin of bisphenol A propylene oxide adduct, hydrogenated bisphenol A (or F) epoxy resin, fluorinated epoxy resin, rubber-modified epoxy resin containing polybutadiene or NBR, flame-resistant epoxy resin such as glycidyl ether of tetrabromo bisphenol A, p-oxybenzoic acid glycidyl ether ester type epoxy resin, m-aminophenol type epoxy resin, diaminodiphenylmethane-based epoxy resin, urethane-modified epoxy resin containing urethane bond, various types of alicyclic epoxy resin, glycidyl ether of a polyhydric alcohol, hydantoin-type epoxy resin, epoxidized unsaturated polymer such as petroleum resin, and amino-containing glycidyl ether resin. Examples of the polyhydric alcohol encompass N,N-diglycidyl aniline, N,N-diglycidyl-o-toluidine, triglycidyl isocyanurate, polyalkylene glycol diglycidyl ether, and glycerin. Other examples of the epoxy resins encompass an epoxy compound obtained by causing an addition reaction between one of the above epoxy resins and e.g. a bisphenol A (or F) or a polybasic acid. The epoxy resins are not limited to these examples. Typically used epoxy resins can be used as the epoxy resins. These epoxy resins may be used alone or in combination of two or more.

Out of these epoxy resins, epoxy resins each of which has at least two epoxy groups in one molecule are preferable in that, e.g., such resins have high reactivity during curing of the resin composition and make it easy for an obtained cured product to create a three-dimensional mesh. In addition, out of the epoxy resins each of which has at least two epoxy groups in one molecule, epoxy resins each of which contains a bisphenol type epoxy resin as a main component are preferable, because they are economical and easily available.

(Phenolic Resins)

The phenolic resins are not limited to any particular ones, provided that the phenolic resins are each a compound obtained through a reaction between a phenol and an aldehyde. The phenol is not limited to any particular one, and examples thereof encompass phenols such as phenol, ortho-cresol, meta-cresol, para-cresol, xylenol, para-tertiary butylphenol, para-octylphenol, para-phenylphenol, bisphenol A, bisphenol F, and resorcin. In particular, phenol and cresol are preferred as the phenol.

The aldehyde is not limited to any particular one, and examples thereof encompass formaldehyde, acetaldehyde, butylaldehyde, and acrolein, and mixtures thereof. Alternatively, substances which are sources of the above aldehydes or solutions of the above aldehydes can be used. The aldehyde is preferably formaldehyde because an operation for reacting the phenol and the aldehyde is easy.

The molar ratio (F/P) between the phenol (P) and the aldehyde (F) in a reaction between the phenol and the aldehyde (such a molar ratio may be hereinafter referred to as a “reaction molar ratio”) is not limited to any particular one. In a case where an acid catalyst is used in the reaction, the reaction molar ratio (F/P) is preferably 0.4 to 1.0, more preferably 0.5 to 0.8. In a case where an alkali catalyst is used in the reaction, the reaction molar ratio (F/P) is preferably 0.4 to 4.0, more preferably 0.8 to 2.5. In a case where the reaction molar ratio is equal to or higher than the above lower limit, a yield is less likely to excessively decrease and a resulting phenolic resin is less likely to have a low molecular weight. On the contrary, in a case where the reaction molar ratio is equal to or lower than the above upper limit, the phenolic resin is less likely to have an excessively high molecular weight and an excessively high softening point, and it is therefore possible to achieve sufficient flowability during heating. Furthermore, in a case where the reaction molar ratio is equal to or lower than the above upper limit, the molecular weight is easily controlled, and gelation may be less likely to occur or a partially gelatinized product may be less likely to be formed, each of which results from the conditions under which the reaction takes place.

(Polyol Resins)

The polyol resins are each a compound containing two or more active hydrogens as its terminal group(s), and are each bi- or more functional polyol with a molecular weight of about 50 to 20,000. Examples of the polyol resins encompass aliphatic alcohols, aromatic alcohols, polyether type polyols, polyester type polyols, polyolefin polyols, and acrylic polyols.

The aliphatic alcohols may be dihydric alcohols or trihydric or higher polyhydric alcohols (such as trihydric alcohols or tetrahydric alcohols). Examples of the dihydric alcohols encompass: alkylene glycols (in particular, alkylene glycols having about 1 to 6 carbon atoms) such as ethylene glycol, propylene glycol, 1,3-propanediol, 1,3-butanediol, 1,4-butanediol, 1,5-pentanediol, 1,6-hexanediol, 3-methyl-1,5-pentanediol, and neopentylglycol; and substances obtained through dehydrogenative condensation of two or more molecules (e.g., about two to six molecules) of any of the above alkylene glycols (such as diethylene glycol, dipropylene glycol, and tripropylene glycol). Examples of the trihydric alcohols encompass glycerin, trimethylolpropane, trimethylolethane, and 1,2,6-hexanetriol (in particular, trihydric alcohols having about 3 to 10 carbon atoms). Examples of the tetrahydric alcohols encompass pentaerythritol and diglycerin. Other examples encompass saccharides such as monosaccharides, oligosaccharides, and polysaccharides.

Examples of the aromatic alcohols encompass: bisphenols such as bisphenol A and bisphenol F; biphenyls such as dihydroxybiphenyl; polyhydric phenols such as hydroquinone and phenol-formaldehyde condensate; and naphthalenediol.

Examples of the polyether type polyols encompass: random copolymers and block copolymers obtained by ring-opening polymerization of ethylene oxide, propylene oxide, butylene oxide, styrene oxide, or the like in the presence of one or more active-hydrogen-containing initiators; and mixtures of these copolymers. Examples of the active-hydrogen-containing initiators used for the ring-opening polymerization to obtain the polyether type polyols encompass diols such as ethylene glycol, diethylene glycol, propylene glycol, dipropylene glycol, 1,3-butanediol, 1,4-butanediol, 1,6-hexanediol, neopentylglycol, and bisphenol A; triols such as trimethylolethane, trimethylolpropane, and glycerin; saccharides such as monosaccharides, oligosaccharides, and polysaccharides; sorbitol; and amines such as ammonia, ethylenediamine, urea, monomethyl diethanolamine, and monoethyl diethanolamine.

Examples of the polyester type polyols encompass polymers obtained by, in the presence of an esterification catalyst at a temperature falling within the range of 150° C. to 270° C., polycondensation of, for example, (a) a polybasic acid, such as maleic acid, fumaric acid, adipic acid, sebacic acid, phthalic acid, dodecanedioic acid, isophthalic acid, or azelaic acid, and/or an acid anhydride thereof and (b) a polyhydric alcohol such as ethylene glycol, propylene glycol, 1,4-butanediol, 1,6-hexanediol, diethylene glycol, dipropylene glycol, neopentylglycol, or 3-methyl-1,5-pentanediol. Examples of the polyester type polyols further encompass (a) polymers obtained by ring-opening polymerization of F-caprolactone, valerolactone, or the like; and (b) active hydrogen compounds containing two or more active hydrogens, such as polycarbonate diol and castor oil.

Examples of the polyolefin type polyols encompass polybutadiene polyol, polyisoprene polyol, and hydrogenated versions thereof.

Examples of the acrylic polyols encompass: copolymers of, for example, (a) a hydroxyl-containing monomer such as hydroxyethyl (meth)acrylate, hydroxybutyl (meth)acrylate, or vinylphenol and (b) a general-purpose monomer such as n-butyl (meth)acrylate or 2-ethylhexyl (meth)acrylate; and mixtures thereof.

Out of these polyol resins, the polyether type polyols are preferred, because the resulting resin composition has a lower viscosity and has excellent workability, and the resin composition can provide the cured product which is well balanced between its hardness and toughness. Further, out of these polyol resins, the polyester type polyols are preferred, because the resulting resin composition can provide the cured product which has excellent adhesiveness.

(Amino-Formaldehyde Resins)

The amino-formaldehyde resins are not limited to any particular ones, provided that the amino-formaldehyde resins are each a compound obtained through a reaction between an amino compound and an aldehyde in the presence of an alkaline catalyst. Examples of the amino compound encompass: melamine; 6-substituted guanamines such as guanamine, acetoguanamine, and benzoguanamine; amine-substituted triazine compounds such as CTU guanamine (3,9-bis[2-(3,5-diamino-2,4,6-triazaphenyl)ethyl]-2,4,8,10-tetraoxaspiro[5,5]undecane) and CMTU guanamine (3,9-bis[(3,5-diamino-2,4,6-triazaphenyl)methyl]-2,4,8,10-tetraoxaspiro[5,5]undecane); and ureas such as urea, thiourea, and ethyleneurea. Examples of the amino compound also encompass: substituted melamine compounds which are different from melamine in that the hydrogen of an amino group is substituted by an alkyl group, an alkenyl group, and/or a phenyl group (described in Specification of U.S. Pat. No. 5,998,573 (a Japanese family member thereof: Japanese Patent Application Publication Tokukaihei No. 9-143238)); and substituted melamine compounds which are different from melamine in that the hydrogen of an amino group is substituted by a hydroxyalkyl group, a hydroxyalkyloxyalkyl group, and/or an aminoalkyl group (described in Specification of U.S. Pat. No. 5,322,915 (a Japanese family member thereof: Japanese Patent Application Publication Tokukaihei No. 5-202157)). Out of the above-listed compounds, melamine, guanamine, acetoguanamine and benzoguanamine, which are polyfunctional amino compounds, are preferable, and melamine is particularly preferable, as the amino compound, because they are industrially produced and inexpensive. The above-listed amino compounds may be used alone or in combination of two or more. In addition to these amino compounds, any of (a) phenols, such as phenol, cresol, alkylphenol, resorcin, hydroquinone, and/or pyrogallol, (b) anilines, and the like may be used.

Examples of the aldehyde encompass formaldehyde, paraformaldehyde, acetaldehyde, benzaldehyde, and furfural. Preferred aldehydes are formaldehyde and paraformaldehyde, because they are inexpensive and well react with the foregoing amino compound. In producing an amino-formaldehyde resin, the aldehyde may be used in the following amount: the amount of an effective aldehyde group in the aldehyde compound is preferably 1.1 mol to 6.0 mol, particularly preferably 1.2 mol to 4.0 mol, per mole of the amino compound.

(Physical Properties of Thermosetting Resin)

The thermosetting resin is not particularly limited in terms of the properties thereof. The thermosetting resin preferably has a viscosity of 100 mPa·s to 1,000,000 mPa·s at 25° C. The viscosity of the thermosetting resin is more preferably not more than 50,000 mPa·s, even more preferably not more than 30,000 mPa·s, and particularly preferably not more than 15,000 mPa·s, at 25° C. According to the above feature, the thermosetting resin has an advantage of having excellent flowability. It can also be said that the thermosetting resin having a viscosity of 100 mPa·s to 1,000,000 mPa·s at 25° C. is a liquid.

As the flowability of the thermosetting resin becomes greater, in other words, as the viscosity of the thermosetting resin becomes lower, it becomes more difficult to disperse, in the thermosetting resin, the fine polymer particles (A) in the form of primary particles. Conventionally, it has been extremely difficult to disperse, in the thermosetting resin having a viscosity of not more than 1,000,000 mPa·s at 25° C., the fine polymer particles (A) in the form of the primary particles. However, the resin composition in accordance with one or more embodiments of the present invention has an advantage that the fine polymer particles (A) having the above feature are well dispersed in the thermosetting resin having a viscosity of not more than 1,000,000 mPa·s at 25° C.

Further, the viscosity of the thermosetting resin is more preferably not less than 100 mPa·s, even more preferably not less than 500 mPa·s, still more preferably not less than 1000 mPa·s, and particularly preferably not less than 1500 mPa·s at 25° C., because such a viscosity allows the thermosetting resin to get between the fine polymer particles (A) and thereby allows prevention of fusion between the fine polymer particles (A).

The thermosetting resin may have a viscosity of more than 1,000,000 mPa·s. The thermosetting resin may be a semisolid (semiliquid) or may be alternatively a solid. In a case where the thermosetting resin has a viscosity of more than 1,000,000 mPa·s, the resulting resin composition has advantages that the resin composition is less sticky and easy to handle.

The thermosetting resin may have an endothermic peak at not higher than 25° C., or not higher than 0° C., in its differential scanning calorimetry (DSC) thermogram. According to the above feature, the thermosetting resin has an advantage of having excellent flowability.

(5-2. Blending Ratio Between the Present Resin Composition and Matrix Resins, Etc.)

The blending ratio between the present resin composition and the matrix resin is as follows. In a case where the total amount of the present resin composition and the matrix resin is regarded as 100% by weight, usually the amount of the present resin composition may be 0.5% by weight to 50% by weight and the amount of the matrix resin may be 50% by weight to 99.5% by weight, the amount of the present resin composition may be 1% by weight to 35% by weight and the amount of the matrix resin may be 65% by weight to 99% by weight, the amount of the present resin composition may be 1.5% by weight to 25% by weight and the amount of the matrix resin be 75% by weight to 98.5% by weight, or the amount of the present resin composition may be 2.5% by weight to 20% by weight and the amount of the matrix resin be 80% by weight to 97.5% by weight.

In a case where the matrix resin is the thermosetting resin, the state of the matrix resin is not limited to any particular one, provided that the matrix resin is flowable when mixed with the present resin composition. The matrix resin may be a solid at a room temperature. In terms of achieving workability, the matrix resin may be a liquid.

The temperature at which the present resin composition is mixed with such a thermosetting matrix resin is generally the temperature at which the thermosetting matrix resin can flow. However, in a case where the resin (B) can flow at the temperature at which the thermosetting matrix resin can flow, it is easy to uniformly mix the resin (B) and the thermosetting matrix resin. On the contrary, in a case where the thermosetting matrix resin is a liquid and an epoxy resin contained in the present resin composition to be added to the thermosetting matrix resin is a solid, it is difficult to uniformly mix the thermosetting matrix resin and the present resin composition. Note that, in the present specification, in a case where the thermosetting matrix resin is a liquid at 25° C., it is understood that “the viscosity of the thermosetting matrix resin at 25° C. is equal to or higher than the viscosity of the resin (B) at 25° C.”.

(5-3. Other Components)

In terms of achieving an anti-blocking property and improving the dispersibility in the thermosetting matrix resin, a mixture of the present resin composition and the matrix resin may further contain an anti-blocking agent. The anti-blocking agent is not limited to any particular one, provided that the anti-blocking agent brings about the foregoing effects. Examples of the anti-blocking agent encompass: anti-blocking agents composed of inorganic fine particles, such as fine particles of silicon dioxide, titanium oxide, aluminum oxide, zirconium oxide, aluminum silicate, diatomaceous earth, zeolite, kaolin, talc, calcium carbonate, calcium phosphate, barium sulfate, and magnesium hydrosilicate; anti-blocking agents composed of organic fine particles; and fat-based and/or oil-based anti-blocking agents such as polyethylene wax, higher fatty acid amides, metal soap, and silicone oil. Out of these anti-blocking agents, anti-blocking agents composed of fine particles are preferable, anti-blocking agents composed of organic fine particles are more preferable, and anti-blocking agents composed of organic fine particles of a polymer containing at least one type of monomer unit selected from aromatic vinyl monomers, vinyl cyanide monomers, and (meth)acrylate monomers are particularly preferable.

An anti-blocking agent composed of fine particles, in general, is in the form of a dispersion composed of the fine particles and a medium in which the fine particles are dispersed or is in the form of a colloid. The fine particles in the anti-blocking agent may have a volume-average particle size (Mv) of usually not more than 10 μm, or 0.05 μm to 10 μm. The amount of the anti-blocking agent contained may be 0.01% by weight to 5.0% by weight, or may be 0.5% by weight to 3.0% by weight, with respect to the total weight of the present resin composition and the matrix resin.

The mixture of the present resin composition and the matrix resin may contain, as necessary, any other component which is different from the above-described components. Examples of the any other component encompass: curing agents; coloring agents such as pigments and colorants; extenders; ultraviolet ray absorbing agents; antioxidants; heat stabilizers (antigelling agents); plasticizing agents; leveling agents; defoaming agents; silane coupling agents; antistatic agents; flame retardants; lubricants; viscosity reducers; shrinkage reducing agents; inorganic filler; organic filler; thermoplastic resins; desiccants; and dispersion agents.

The anti-blocking agent and one or more additives (any other component) can be added, as appropriate, during any step of a method of producing the present resin composition. For example, the anti-blocking agent and one or more additives can be added to an aqueous suspension before or after flocculation of the fine polymer particles (A). Alternatively, the anti-blocking agent and one or more additives can be added to the present resin composition or the mixture of the present resin composition and the matrix resin.

The mixture of the present resin composition and the matrix resin may further contain a known thermosetting resin other than the matrix resin, and may further contain a known thermoplastic resin.

[6. Cured Product]

A cured product in accordance with one or more embodiments of the present invention is obtained by curing the resin composition described in the section [5. Resin composition (mixture of the present resin composition and matrix resin)]. The cured product is also simply referred to as a present cured product.

The present cured product has the above-described feature. Therefore, even in a case where the resin composition is applied to a metal plate or the like and is then cured, rust is less likely to form. Moreover, the cured product has (a) an excellent surface appearance, (b) high rigidity and a high elastic modulus, and (c) excellent toughness and excellent adhesiveness.

[7. Other Uses]

The above-describe resin composition and the above-described mixture of the present resin composition and the matrix resin (hereinafter simply referred to as the present resin composition etc.) can be used in various applications, and the applications are not limited to any particular ones. The present resin composition etc. are each preferably used in applications such as, for example, adhesive agents, coating materials, binders for reinforcement fibers, composite materials, molding materials for 3D printers, sealants, electronic substrates, ink binders, wood chip binders, binders for rubber chips, foam chip binders, binders for castings, rock mass consolidation materials for floor materials and ceramics, and urethane foams. Examples of the urethane foams encompass automotive seats, automotive interior parts, sound absorbing materials, damping materials, shock absorbers (shock absorbing materials), heat insulating materials, and floor material cushions for construction.

The present resin composition etc. may be used for, out of the above applications, adhesive agents, coating materials, binders for reinforcement fibers, composite materials, molding materials for 3D printers, sealants, and electronic substrates.

(7-1. Adhesive Agent)

An adhesive agent in accordance with one or more embodiments of the present invention contains the above-described present resin composition etc. The adhesive agent in accordance with one or more embodiments of the present invention has the above feature, and therefore has excellent adhesiveness.

The adhesive agent in accordance with one or more embodiments of the present invention is also simply referred to as a present adhesive agent.

The present adhesive agent can be suitably used in various applications such as automotive interior materials, general woodworking, furniture, interior decoration, wall materials, and food packaging.

The present adhesive agent exhibits favorable adhesiveness to various adherends such as cold-rolled steel, aluminum, fiberglass-reinforced polyester (FRP), panels made of cured products obtained by curing thermosetting resins (for example, epoxy resin) reinforced with carbon fibers, panels made of thermoplastic resin sheets reinforced with carbon fibers, sheet molding compounds (SMC), an acrylonitrile-butadiene-styrene copolymer (AB S), polyvinyl chloride (PVC), polycarbonate, polypropylene, TPO, wood, and glass.

The present adhesive agent has excellent adhesiveness and excellent plasticity not only at low temperatures (approximately −20° C.) to ordinary temperatures but also at high temperatures (approximately 80° C.). Therefore, the present adhesive agent can be more suitably used as an adhesive agent for structures.

The adhesive agent for structures which employs the present adhesive agent can be used as an adhesive agent for, for example, structural members in the fields of automobiles, vehicles (for example, shinkansen (bullet trains) and trains), civil engineering, construction, building materials, woodworking, electricity, electronics, aircrafts, space industry, and the like. Specific examples of automobile-related applications encompass: bonding of interior materials such as ceilings, doors, and seats; bonding of automotive luminaires such as lamps; and bonding of exterior materials such as body side molding.

The present adhesive agent can be produced from the present resin composition etc. A method of producing the present adhesive agent is not limited to any particular one, and a known method can be employed.

(7-2. Coating Material)

A coating material in accordance with one or more embodiments of the present invention contains the above-described present resin composition etc. The coating material in accordance with one or more embodiments of the present invention has the above feature, and therefore can provide a coating film having an excellent load bearing property and excellent wear resistance.

The coating material in accordance with one or more embodiments of the present invention is also simply referred to as a present coating material.

In a case where the present coating material is applied to, for example, a floor or a corridor, a generally used application method can be employed. For example, after a primer is applied to a base material which has been subjected to surface preparation, the primer is uniformly coated with the present coating material with use of a trowel, a roller, a rake, a spray gun, and/or the like depending on conditions under which the primer is coated with the present coating material. After the primer is coated with the present coating material, curing of the present coating material proceeds, so that a good-performance coating is obtained. The coating film obtained by curing the present coating material can be a coating film having excellent load bearing and excellent wear resistance.

Depending on a method of applying the present coating material, the viscosity of the resin composition used for the coating material may be adjusted. For example, in a case where a trowel or a rake is used to apply the present coating material, the viscosity of the resin composition used for the present coating material can be adjusted to, generally, approximately 500 cps/25° C. to 9,000 cps/25° C. In a case where a roller or a spray is used to apply the present coating material, the viscosity of the resin composition used for the present coating material can be adjusted to, generally, approximately 100 cps/25° C. to 3,000 cps/25° C.

The base material (in other words, the material of the floor or the corridor) to which the present coating material is applied is not limited to any particular one. Specific examples of the base material encompass: (a) inorganic base materials such as concrete walls, concrete plates, concrete blocks, concrete masonry unit (CMU), mortar plates, autoclaved light-weight concrete (ALC) plates, gypsum boards (such as Dens Glass Gold manufactured by Georgia Pacific), and slate boards; (b) organic base materials such as wood-based base materials (such as wood, plywood, and oriented strand board (OSB)), asphalt, waterproof sheets made of modified bitumen, waterproof sheets made of ethylene-propylene-diene rubber (EPDM), waterproof sheets made of TPO, plastics, FRP, and urethane foam heat insulating materials; and (c) metal-based base materials such as metal panels.

A case will be described where the present coating material is applied to a metal base material or a porous base material. A laminate, obtained by applying and then curing the present coating material, is excellent in resistance of such a base material to corrosion. Furthermore, a coating film, obtained by applying and then curing the present coating material, can impart excellent crack resistance and excellent load bearing to the base material. Therefore, a mode in which the present coating material is applied to a metal base or a porous base material is a particularly preferable mode.

A method of applying the present coating material is not limited to any particular one, and the present coating material can be applied by a known method such as a trowel, a rake, a brush, a roller, an air spray, and/or an airless spray.

The present coating material is not particularly limited in terms of applications. For example, the present coating material can be used for automobiles, electric apparatuses, office equipment, construction materials, wood, coated floors, paving, heavy-duty anticorrosion, anticorrosion of concrete, waterproofing of rooftops and roofs, anticorrosion of rooftops and roofs, waterproof coating films for underground waterproofing, automotive refinishing, can coating, topcoat, intercoat, undercoat, primer, electro-deposition paint, highly weather resistant paint, non-yellowing paint, and the like. In a case where the present coating material is used for a coating material for coated floors, a coating material for paving, and the like, the present coating material can be used in factories, laboratories, warehouses, clean rooms, and the like.

The present coating material can be produced with use of the present resin composition etc. A method of producing the present coating material is not limited to any particular one, and a known method can be employed.

(7-3. Composite Material)

A composite material in accordance with one or more embodiments of the present invention contains, as a binder for reinforcement fibers, the above-described present resin composition etc. The composite material in accordance with one or more embodiments of the present invention has the above feature, and therefore has an advantage of having excellent toughness and excellent impact resistance.

The composite material in accordance with one or more embodiments of the present invention is also simply referred to as a present composite material.

The present composite material can contain reinforcement fibers. The reinforcement fibers are not limited to any particular ones. Example of the reinforcement fibers encompass glass fibers, continuous glass fibers, carbon fibers, natural fibers, metal fibers, thermoplastic resin fibers, boron fibers, aramid fibers, polyethylene fibers, and xyron-reinforced fibers. Out of these reinforcement fibers, glass fibers and carbon fibers are particularly preferable.

A method of producing the present composite material (molding method) is not limited to any particular one. Examples of the method encompass: an autoclave molding method in which a prepreg is used; a filament winding molding method; a hand lay-up molding method; a vacuum bag molding method; a resin transfer molding (RTM) method; a vacuum-assisted resin transfer molding (VARTM) method; a pultrusion molding method; an injection molding method, a sheet winding molding method; a spray up molding method; a bulk molding compound (BMC) method; and a sheet molding compound (SMC) method.

In particular, in a case where carbon fibers are used as the reinforcement fibers, an autoclave molding method in which a prepreg is used; a filament winding molding method; a hand lay-up molding method; a vacuum bag molding method; a resin transfer molding (RTM) method; a vacuum-assisted resin transfer molding (VARTM) method; or the like may be employed as the method of producing the present composite material.

The present composite material is not particularly limited in terms of applications. For example, the present composite material can be used for aircrafts, spacecrafts, automobiles, bicycles, watercrafts, weapons, wind turbines, sports goods, containers, building materials, waterproof materials, printed circuit boards, electrically insulating materials, and the like.

The present composite material can be produced with use of the present resin composition etc. In regard to further details of the reinforcement fibers, the production method (molding method), producing conditions (molding conditions), agents blended, applications, and the like concerning the present composite material, any of those disclosed in the following documents can be employed: United States Patent Application Publication No. 2006/0173128, United States Patent Application Publication No. 2012/0245286, Published Japanese Translation of PCT International Application, Tokuhyo, No. 2002-530445 (PCT International Application WO2000/029459), Japanese Patent Application Publication, Tokukaisho, No. 55-157620 (U.S. Pat. No. 4,251,428), Published Japanese Translation of PCT International Application, Tokuhyo, No. 2013-504007 (PCT International Application WO2011/028271), Japanese Patent Application Publication, Tokukai, No. 2007-125889 (United States Patent Application Publication No. 2007/0098997), and Japanese Patent Application Publication, Tokukai, No. 2003-220661 (United States Patent Application Publication No. 2003/0134085).

(7-4. Molding Material for 3D Printer)

A molding material for 3D printers in accordance with one or more embodiments of the present invention contains the above-described present resin composition etc. The molding material for 3D printers in accordance with one or more embodiments of the present invention has the above feature, and therefore has an advantage of having excellent toughness and excellent impact resistance.

The molding material for 3D printers in accordance with one or more embodiments of the present invention is also simply referred to as a present molding material.

The present molding material is not particularly limited in terms of applications. The present molding material can be used for goods made as samples for testing design, functions, and the like before actual products are made; aircraft parts; construction members; and parts of medical equipment.

The present molding material can be produced with use of the present resin composition etc. A method of producing the present molding material is not limited to any particular one, and a known method can be employed.

(7-5. Sealant)

A sealant in accordance with one or more embodiments of the present invention is obtained with use of the above-described present resin composition etc. The sealant in accordance with one or more embodiments of the present invention has the above feature, and therefore has an advantage of having excellent toughness and excellent impact resistance.

The sealant in accordance with one or more embodiments of the present invention is also simply referred to as a present sealant.

The present sealant is not particularly limited in terms of applications. For example, the present sealant can be used for sealing of various electric apparatuses (such as semiconductors), power devices, and the like.

The present sealant can be produced with use of the present resin composition etc. A method of producing the present sealant is not limited to any particular one, and a known method can be employed.

(7-6. Electronic Substrate)

An electronic substrate in accordance with one or more embodiments of the present invention is obtained with use of the above-described present resin composition etc. The electronic substrate in accordance with one or more embodiments of the present invention has the above feature, and therefore has an advantage of having excellent toughness and excellent impact resistance.

The electronic substrate in accordance with one or more embodiments of the present invention is also simply referred to as a present electronic substrate.

The present electronic substrate is not particularly limited in terms of applications. For example, the present electronic substrate can be used for printed circuits, printed wiring, printed circuit boards, products provided with printed circuits therein, printed wiring boards, and printed boards.

The present electronic substrate can be produced from the present resin composition etc. with use of the present resin composition etc. A method of producing the present electronic substrate is not limited to any particular one, and a known method can be employed.

One or more embodiments of the present invention include the following.

(1) A method of producing a resin composition, including: a rapid freezing step of rapidly freezing a latex containing fine polymer particles (A); a thawing step of thawing the latex which has been frozen in the rapid freezing step; a resin mixing step of mixing, into the latex which has been subjected to the rapid freezing step, a resin (B) which is, at 25° C., a liquid having a viscosity of 100 mPa·s to 1,000,000 mPa·s, a semisolid, or a solid; and after the thawing step and the resin mixing step, a separating step of separating the latex into a resin composition and a water component, the resin composition being an agglutinate containing the fine polymer particles (A) and the resin (B).

(2) A method of producing a resin composition, including: a resin mixing step of mixing, into a latex containing fine polymer particles (A), a resin (B) which is, at 25° C., a liquid having a viscosity of 100 mPa·s to 1,000,000 mPa·s, a semisolid, or a solid; a freezing step of freezing the latex which has been obtained in the resin mixing step and in which the resin (B) is dispersed; a thawing step of thawing the latex which has been frozen in the freezing step; and after the thawing step, a separating step of separating the latex into a resin composition and a water component, the resin composition being an agglutinate containing the fine polymer particles (A) and the resin (B).

(3) The method as described in (2), further including, before the freezing step, a removing step of removing the agglutinate which has been generated in the resin mixing step.

(4) A method of producing a resin composition, including: a resin mixing step of mixing, into a latex containing fine polymer particles (A), a resin (B) which is, at 25° C., a liquid having a viscosity of 100 mPa·s to 1,000,000 mPa·s, a semisolid, or a solid; a shearing step of applying shearing stress to the latex which has been obtained in the resin mixing step; and after the shearing step, a first separating step of separating the latex into a resin composition and a water component, the resin composition being an agglutinate containing the fine polymer particles (A) and the resin (B).

(5) The method as described in (4), further including: an agglutinating step of agglutinating the fine polymer particles (A) and the resin (B) contained in the water component from which the agglutinate has been separated in the first separating step, so as to obtain the resin composition which is the agglutinate containing the fine polymer particles (A) and the resin (B); and after the agglutinating step, a second separating step of separating the resin composition, which is the agglutinate containing the fine polymer particles (A) and the resin (B), and the water component.

(6) The method as described in (5), wherein the agglutinating step includes a step of freezing the water component from which the agglutinate has been separated in the first separating step.

(7) The method as described in any one of (1), (2), (4), and (5), wherein the separating step, the first separating step, or the second separating step includes a step of adjusting a water content of the agglutinate to 5% by weight to 60% by weight with respect to 100% by weight of the agglutinate.

(8) The method as described in any one of (1) through (7), further including a washing step of washing the resin composition.

(9) The method as described in any one of (1) through (8), wherein, in a case where a total amount of the fine polymer particles (A) and the resin (B) is regarded as 100% by weight, an amount of the fine polymer particles (A) is 1% by weight to 70% by weight and an amount of the resin (B) is 30% by weight to 99% by weight.

(10) A resin composition containing: fine polymer particles (A) which have a graft part that is constituted by a polymer containing, as one or more structural units, one or more structural units derived from at least one type of monomer selected from the group consisting of aromatic vinyl monomers, vinyl cyanide monomers, and (meth)acrylate monomers; and a resin (B) which is, at 25° C., a liquid having a viscosity of 100 mPa·s to 1,000,000 mPa·s, a semisolid, or a solid, in a case where a total amount of the fine polymer particles (A) and the resin (B) is regarded as 100% by weight, an amount of the fine polymer particles (A) being 1% by weight to 70% by weight and an amount of the resin (B) being 30% by weight to 99% by weight, in a case where an amount of the fine polymer particles (A) contained in the resin (B) is 5% by weight, dispersibility of the fine polymer particles (A) in the resin (B) being not more than 0 μm when evaluated in accordance with JIS K5101 with use of a grind gauge, the resin composition substantially not containing an organic solvent, the resin composition containing sulfur (S) and phosphorus (P) each in an amount of not more than 150 ppm, the resin composition having an electric conductivity of not more than 0.6 mS/cm.

(11) The resin composition as described in (10), wherein the resin composition contains calcium (Ca), magnesium (Mg), iron (Fe), zinc (Zn), barium (Ba), and aluminum (Al) each in an amount of not more than 100 ppm.

(12) The resin composition as described in (10) or (11), wherein the fine polymer particles (A) are constituted by a rubber-containing graft copolymer which has an elastic body and the graft part grafted to the elastic body.

(13) The resin composition as described in (12), wherein the elastic body includes at least one type of elastic body selected from the group consisting of diene-based rubbers, (meth)acrylate-based rubbers, and polysiloxane rubber-based elastic bodies.

(14) The resin composition as described in any one of (10) through (13), wherein the resin (B) includes a thermosetting resin.

### EXAMPLES

The following description will discuss one or more embodiments of the present invention in detail with reference to Examples and Comparative Examples. Note that one or more embodiments of the present invention are not limited to these examples. One or more embodiments of the present invention can be altered as appropriate within the scope of the gist disclosed herein. One or more embodiments of the present invention also include their technical scope, embodiments achieved by altering the embodiments. Note that in the following Examples and Comparative Examples, “parts” means “parts by weight”, and “%” means “% by weight”

[Evaluation Method]

First, the following description will discuss methods of evaluating resin compositions produced in Examples and Comparative Examples.

<Measurement of Volume-Average Particle Size>

The volume-average particle size (Mv) of an elastic body or fine polymer particles (A) dispersed in an aqueous latex was measured with use of Nanotrac WaveII-EX150 (manufactured by MicrotracBEL Corp.). A test specimen used for measurement was prepared by diluting the aqueous latex in deionized water. When the measurement was made, the refractive index of water and the refractive index of the elastic body or the fine polymer particles (A) obtained in each of Production Examples were inputted, measurement time was set to 120 seconds, and the concentration of the test specimen was adjusted such that a load index fell within the range of 1 to 20.

<Differential Scanning Calorimetry (DSC) of Resin (B)>

The differential scanning calorie of a liquid epoxy resin (JER828, manufactured by Mitsubishi Chemical Corporation), which was a resin (B) used in each of Examples and Comparative Examples below, was measured with use of DSC7020 (manufactured by Hitachi High-Tech Science Corporation). A rate of temperature rise was set to 10° C./min. As a result, the liquid epoxy resin was found to have an endothermic peak at −15° C.

<Measurement of Viscosity>

The viscosity of the liquid epoxy resin (JER828, manufactured by Mitsubishi Chemical Corporation), which was the resin (B) used in each of Examples and Comparative Examples below, or the viscosity of a resin composition obtained in each of Examples and Comparative Examples below was measured. A device used was a digital viscometer DV-II+Pro manufactured by BROOKFIELD FIELD. Further, a spindle CPE-52 was used for some viscosity ranges. The viscosity was measured at a temperature of 25° C., while a shear rate was changed as necessary. As a result, the viscosity of the liquid epoxy resin was 12,000 mPa·s.

<Evaluation of Dispersibility>

The resin (B) was further added to the obtained resin composition to obtain a composition in which the amount of the fine polymer particles (A) contained in the resin (B) was 5% by weight. The dispersibility of the fine polymer particles (A) in the resin (B) in the composition thus obtained was evaluated in accordance with JIS K5101 with use of a grind gauge. Specifically, evaluation was made as follows. The composition was placed on a grind gauge, the composition on a gauge was scraped with use of a metal scraper, and the state of dispersion was visually checked. The point on the scale of the grind gauge, at which there are 5 to 10 particles (which became apparent by scraping) within a range 3 mm in width, was read. Note that the lower an obtained value is, the more excellent the dispersibility is.

<Measurement of Solvent Content of Resin Composition>

The solvent content of the obtained resin composition was measured with use of gas chromatography (GC-2014, manufactured by Shimadzu Corporation).

<Measurement of S, P, Ca, Mg, Fe, Zn, Ba, and Al in Resin Composition>

The amounts of S, P, Ca, Mg, Fe, Zn, Ba, and Al contained in the resin composition were measured with use of an X-ray fluorescence analyzer SPECTROXEPOS (manufactured by SPECTRO).

<Measurement of Electric Conductivity>

In a stirred tank, 100 g of the resin composition and 100 g of ion exchanged water were stirred at 90° C. and 900 rpm for 30 minutes. Thereafter, oil-water separation was carried out, rinse water was taken out, and electric conductivity was measured with use of a portable electric conductivity meter (manufactured by HORIBA, Ltd.).

### 1. Formation of Elastic Body by Polymerization

### Production Example 1-1: Preparation of Polybutadiene Rubber Latex (R-1)

Into a pressure-resistant polymerization apparatus were introduced 200 parts of deionized water, 0.03 parts of tripotassium phosphate, 0.002 parts of disodium ethylenediaminetetraacetate (EDTA), 0.001 parts of ferrous sulfate heptahydrate, and 1.55 parts of sodium dodecylbenzenesulfonate (SDBS), which was an emulsifying agent. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 100 parts of butadiene (Bd) was introduced into the pressure-resistant polymerization apparatus, and the temperature inside the pressure-resistant polymerization apparatus was raised to 45° C. Subsequently, 0.03 parts of paramenthane hydroperoxide (PHP) was introduced into the pressure-resistant polymerization apparatus, and then 0.10 parts of sodium formaldehyde sulfoxylate (SFS) was introduced into the pressure-resistant polymerization apparatus. Polymerization was then started. At the time 15 hours had elapsed from the start of the polymerization, devolatilization was carried out under reduced pressure to remove a remaining monomer that had not been used in the polymerization, so as to end the polymerization. During the polymerization, PHP, EDTA, and ferrous sulfate heptahydrate were each added to the pressure-resistant polymerization apparatus in discretionarily selected amounts and discretionarily selected points in time. By the polymerization, an aqueous latex (R-1), which contained an elastic body containing polybutadiene rubber as a main component, was obtained. The volume-average particle size of the elastic body contained in the obtained aqueous latex was 90 nm.

### Production Example 1-2: Preparation of Polybutadiene Rubber Latex (R-2)

Into a pressure-resistant polymerization apparatus were introduced 7 parts of a solid content of the polybutadiene rubber latex (R-1) obtained in Production Example 1-1, 200 parts of deionized water, 0.03 parts of tripotassium phosphate, 0.002 parts of EDTA, and 0.001 parts of ferrous sulfate heptahydrate. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 93 parts of Bd was introduced into the pressure-resistant polymerization apparatus, and the temperature inside the pressure-resistant polymerization apparatus was raised to 45° C. Thereafter, 0.02 parts of PHP was introduced into the pressure-resistant polymerization apparatus, and then 0.10 parts of SFS was introduced into the pressure-resistant polymerization apparatus. Polymerization was then started. At the time 30 hours had elapsed from the start of the polymerization, devolatilization was carried out under reduced pressure to remove a remaining monomer that had not been used in the polymerization, so as to end the polymerization. During the polymerization, PHP, EDTA, ferrous sulfate heptahydrate, and SDBS were each added to the pressure-resistant polymerization apparatus in discretionarily selected amounts and discretionarily selected points in time. By the polymerization, an aqueous latex (R-2), which contained an elastic body containing polybutadiene rubber as a main component, was obtained. The volume-average particle size of the elastic body contained in the obtained aqueous latex was 195 nm.

### Production Example 1-3: Preparation of Polystyrene-Butadiene Rubber Latex (R-3)

Into a pressure-resistant polymerization apparatus were introduced 160 parts of deionized water, 0.002 parts of EDTA, 0.001 parts of ferrous sulfate heptahydrate, 0.029 parts of polyoxyethylene lauryl ether phosphate, and 0.003 parts of sodium hydroxide. In so doing, the polyoxyethylene lauryl ether phosphate turned into sodium polyoxyethylene lauryl ether phosphate in the presence of the sodium hydroxide, and functioned as an emulsifying agent. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 76.5 parts of Bd and 23.5 parts of styrene (St) were introduced into the pressure-resistant polymerization apparatus, and the temperature inside the pressure-resistant polymerization apparatus was raised to 45° C. Thereafter, 0.03 parts of PHP was introduced into the pressure-resistant polymerization apparatus, and then 0.05 parts of SFS was introduced into the pressure-resistant polymerization apparatus. Polymerization was then started. At the time 20 hours had elapsed from the start of the polymerization, devolatilization was carried out under reduced pressure to remove a remaining monomer that had not been used in the polymerization, so as to end the polymerization. During the polymerization, PHP, polyoxyethylene lauryl ether phosphate, and sodium hydroxide were each added to the pressure-resistant polymerization apparatus in discretionarily selected amounts and discretionarily selected points in time. By the polymerization, an aqueous latex (R-3), which contained an elastic body containing polystyrene-butadiene rubber as a main component, was obtained. The volume-average particle size of the elastic body contained in the obtained aqueous latex was 192 nm.

### Production Example 1-4: Preparation of Polybutadiene Rubber Latex (R-4)

Into a pressure-resistant polymerization apparatus were introduced 200 parts by weight of deionized water, 0.03 parts by weight of tripotassium phosphate, 0.002 parts by weight of disodium ethylenediaminetetraacetate (EDTA), 0.001 parts by weight of ferrous sulfate heptahydrate, and 1.55 parts by weight of sodium dodecylbenzenesulfonate (SDBS), which was an emulsifying agent. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 100 parts by weight of butadiene (Bd) was introduced into the pressure-resistant polymerization apparatus, and the temperature inside the pressure-resistant polymerization apparatus was raised to 45° C. Subsequently, 0.03 parts by weight of paramenthane hydroperoxide (PHP) was introduced into the pressure-resistant polymerization apparatus, and then 0.10 parts by weight of sodium formaldehyde sulfoxylate (SFS) was introduced into the pressure-resistant polymerization apparatus. Polymerization was then started. At the time 15 hours had elapsed from the start of the polymerization, devolatilization was carried out under reduced pressure to remove a remaining monomer that had not been used in the polymerization, so as to end the polymerization. During the polymerization, PHP, EDTA, and ferrous sulfate heptahydrate were each added to the pressure-resistant polymerization apparatus in discretionarily selected amounts and discretionarily selected points in time. By the polymerization, an aqueous latex (R-4), which contained an elastic body containing polybutadiene rubber as a main component, was obtained. The volume-average particle size of the elastic body contained in the obtained aqueous latex was 70 nm.

### 2. Preparation of Fine Polymer Particles (A) (Formation of Graft Part by Polymerization)

### Production Example 2-1; Preparation of Fine Polymer Particle Latex (L-1)

Into a glass reaction vessel were introduced 250 parts of the polybutadiene rubber latex (R-2) (including 87 parts of the elastic body containing polybutadiene rubber as a main component) and 50 parts of deionized water. The glass reaction vessel had a thermometer, a stirrer, a reflux condenser, a nitrogen inlet, and a monomer adding device. Gas in the glass reaction vessel was replaced with nitrogen, and the materials thus introduced were stirred at 60° C. Next, 0.004 parts of EDTA, 0.001 parts of ferrous sulfate heptahydrate, and 0.2 parts of SFS were added to the glass reaction vessel, and a resulting mixture was stirred for 10 minutes. Thereafter, a mixture of 12.5 parts of methyl methacrylate (MMA), 0.5 parts of St, and 0.035 parts of t-butyl hydroperoxide (BHP) was added continuously to the glass reaction vessel over 80 minutes. Subsequently, 0.013 parts of BHP was added to the glass reaction vessel, and a resulting mixture in the glass reaction vessel was stirred for 1 hour so as to finish polymerization. Through the above operations was obtained an aqueous latex (L-1) containing fine polymer particles (A) and an emulsifying agent. 99% or more of the monomer component had been polymerized. The volume-average particle size of the fine polymer particles (A) contained in the obtained aqueous latex was 200 nm. The solid content concentration (concentration of the fine polymer particles (A)) of the obtained aqueous latex (L-1) was 30%.

### Production Example 2-2; Preparation of Fine Polymer Particle Latex (L-2)

Into a glass reaction vessel were introduced 250 parts of the polystyrene-butadiene rubber latex (R-3) (including 87 parts of the elastic body containing polystyrene-butadiene rubber as a main component) and 50 parts of deionized water. The glass reaction vessel had a thermometer, a stirrer, a reflux condenser, a nitrogen inlet, and a monomer adding device. Gas in the glass reaction vessel was replaced with nitrogen, and the materials thus introduced were stirred at 60° C. Next, 0.004 parts of EDTA, 0.001 parts of ferrous sulfate heptahydrate, and 0.2 parts of SFS were added to the glass reaction vessel, and a resulting mixture was stirred for 10 minutes. Thereafter, a mixture of 12.5 parts of MMA, 0.5 parts of St, and 0.035 parts of BHP was added continuously to the glass reaction vessel over 80 minutes. Subsequently, 0.013 parts of BHP was added to the glass reaction vessel, and a resulting mixture in the glass reaction vessel was stirred for 1 hour so as to finish polymerization. Through the above operations was obtained an aqueous latex (L-2) containing fine polymer particles (A) and an emulsifying agent. 99% or more of the monomer component had been polymerized. The volume-average particle size of the fine polymer particles (A) contained in the obtained aqueous latex was 200 nm. The solid content concentration (concentration of the fine polymer particles (A)) of the obtained aqueous latex (L-2) was 30%.

### Production Example 2-3; Preparation of Fine Polymer Particle Latex (L-3)

Into a glass reaction vessel was introduced 250 parts by weight of the polybutadiene rubber latex (R-4) (including 83 parts by weight of the elastic body containing polybutadiene rubber as a main component). The glass reaction vessel had a thermometer, a stirrer, a reflux condenser, a nitrogen inlet, and a monomer adding device. Gas in the glass reaction vessel was replaced with nitrogen, and the materials thus introduced were stirred at 60° C. Next, 0.004 parts by weight of EDTA, 0.001 parts by weight of ferrous sulfate heptahydrate, and 0.20 parts by weight of SFS were added to the glass reaction vessel, and a resulting mixture was stirred for 10 minutes. Thereafter, a mixture of 0.8 parts by weight of methyl methacrylate (MMA), 5.4 parts by weight of styrene (St), 3.9 parts by weight of acrylonitrile (AN), 6.9 parts by weight of glycidyl methacrylate (GMA), and 0.043 parts by weight of t-butyl hydroperoxide (BHP) was added continuously to the glass reaction vessel over 120 minutes. Subsequently, 0.013 parts by weight of BHP was added to the glass reaction vessel, and a resulting mixture in the glass reaction vessel was stirred for 1 hour so as to finish polymerization. Through the above operations was obtained an aqueous latex (L-3) containing fine polymer particles (A). 99% or more of the monomer component had been polymerized. The volume-average particle size of the fine polymer particles (A) contained in the obtained aqueous latex was 80 nm. The solid content concentration (concentration of the fine polymer particles (A)) of the obtained aqueous latex (L-3) was 30%.

### Example 1

To a metallic surface at −30° C., 333 g of the aqueous latex (L-1) was fed. The aqueous latex (L-1) was scraped 1 minute later. In this manner, the frozen latex (L-1) was obtained. The frozen latex (L-1) was thawed at an ordinary temperature. The thawed latex (L-1) and 66.7 g of a liquid epoxy resin (JER828, manufactured by Mitsubishi Chemical Corporation, the same was used below) which was a resin (B) were kneaded with use of a continuous type kneader. Next, the latex was separated into a resin composition and a water component, the resin composition being an agglutinate containing the fine polymer particles (A) and the resin (B). Three cycles of the operation of feeding, to a continuous type kneader, the agglutinate (resin composition) thus obtained and 100 g of ion exchanged water and the operation of subjecting a resulting mixture to centrifugal dehydration were carried out in total. As a result, the washed agglutinate was obtained. The agglutinate thus obtained was subjected to vacuum devolatilization at 115° C. so that water was removed. Thereafter, analyses were carried out.

### Comparative Example 1

Instead of the operation of feeding 333 g of the aqueous latex (L-1) to a metallic surface at −30° C. and then scraping the aqueous latex (L-1) 1 minute later, the operation of leaving 333 g of the aqueous latex (L-1) to stand in a freezer at −20° C. for 12 hours was carried out. In this manner, the frozen latex (L-1) was obtained. Except for the above operation, operations similar to those in Example 1 were carried out.

### Example 2

With use of a homomixer, 333 g of the aqueous latex (L-1) was stirred at 12000 rpm. Then, 150 g of a liquid epoxy resin which was a resin (B) was introduced into the homomixer. A resulting mixture was further stirred for 30 minutes. The mixture thus stirred was left to stand in a freezer at −20° C. for 12 hours. In this manner, the frozen latex (L-1) was obtained. The frozen latex (L-1) was thawed by putting a vessel containing the frozen latex (L-1) in hot water at 50° C. The thawed latex (L-1) was separated into a resin composition and a water component, the resin composition being an agglutinate containing the fine polymer particles (A) and the resin (B). Mixed were 200 g of the agglutinate thus obtained and 300 g of ion exchanged water. A resulting mixture was stirred at 90° C. for 30 minutes. The mixture thus obtained was subjected to oil-water separation, and the agglutinate was taken out. The agglutinate thus obtained was subjected to vacuum devolatilization at 115° C. so that water was removed. Thereafter, analyses were carried out.

### Example 3

Operations similar to those in Example 2 were carried out, except that 333 g of the aqueous latex (L-2) was used instead of the aqueous latex (L-1).

### Example 4

With use of a homomixer, 333 g of the aqueous latex (L-1) was stirred at 12000 rpm. Then, 150 g of a liquid epoxy resin which was a resin (B) was introduced into the homomixer. A resulting mixture was further stirred for 30 minutes. The mixture thus stirred was filtered by subjecting the mixture to a 16-mesh metal gauze, and an agglutinate which remained on the metal gauze and a liquid which had passed through the metal gauze (filtrate) were collected. The filtrate thus obtained was left to stand in a freezer at −20° C. for 12 hours. In this manner, the frozen latex (L-1) was obtained. The frozen latex (L-1) was thawed by putting a vessel containing the frozen latex (L-1) in hot water at 50° C. Next, the thawed latex (L-1) and the agglutinate which remained on the metal gauze were kneaded with use of a continuous type kneader. Next, a resulting kneaded mixture (latex) was separated into a resin composition and a water component, the resin composition being an agglutinate containing the fine polymer particles (A) and the resin (B). Mixed were 200 g of the agglutinate thus obtained and 300 g of ion exchanged water. A resulting mixture was stirred at 90° C. for 30 minutes. The mixture thus obtained was subjected to oil-water separation, and the agglutinate was taken out. The agglutinate thus obtained was subjected to vacuum devolatilization at 115° C. so that water was removed. Thereafter, analyses were carried out.

### Example 5

With use of a high shear emulsifier, 333 g of the aqueous latex (L-1) was stirred at 6000 rpm. Then, 66.7 g of a liquid epoxy resin which was a resin (B) was introduced into the high shear emulsifier. A resulting mixture was further stirred for 90 minutes. The mixture (latex) thus stirred was separated into a resin composition and a water component, the resin composition being an agglutinate containing the fine polymer particles (A) and the resin (B). Three cycles of the operation of feeding, to a continuous type kneader, the agglutinate thus obtained and 100 g of ion exchanged water and the operation of subjecting a resulting mixture to centrifugal dehydration were carried out in total. As a result, the washed agglutinate was obtained. The agglutinate thus obtained was subjected to vacuum devolatilization at 115° C. so that water was removed. Thereafter, analyses were carried out.

### Example 6

With use of a high shear emulsifier, 333 g of the aqueous latex (L-1) was stirred at 6000 rpm. Then, 66.7 g of a liquid epoxy resin which was a resin (B) was introduced into the high shear emulsifier. A resulting mixture was further stirred for 90 minutes. The mixture (latex) thus stirred was separated into a resin composition and a water component, the resin composition being an agglutinate containing the fine polymer particles (A) and the resin (B). Next, the water component thus obtained was left to stand in a freezer at −20° C. for 12 hours. In this manner, a frozen water component was obtained. The frozen water component was thawed. Subsequently, the thawed water component was mixed with the agglutinate. A mixture (latex) thus obtained was separated into a resin composition and a water component, the resin composition being an agglutinate containing the fine polymer particles (A) and the resin (B). Thereafter, operations similar to those in Example 4 were carried out.

### Example 7

Operations similar to those in Example 2 were carried out, except that 333 g of the aqueous latex (L-3) was used instead of the aqueous latex (L-1).

### Comparative Example 2

To 333 g of the aqueous latex (L-1), 20 g of 24% sodium sulfate was added. These materials were mixed with use of a spatula, so that an agglutinate containing the fine polymer particles (A) was obtained. The latex was then separated into the agglutinate and a water component. The agglutinate thus obtained and 500 g of ion exchanged water were mixed. A resulting mixture was stirred at 50° C. for 30 minutes. The mixture thus stirred was subjected to filtration under reduced pressure so that rinse water was removed from the mixture. These operations (i.e., mixing of the agglutinate and ion exchanged water, stirring of a resulting mixture, and filtration of the mixture under reduced pressure for removal of rinse water) were repeated another two times (three times in total), and the agglutinate was obtained. The agglutinate thus obtained and 150 g of a liquid epoxy resin were kneaded with use of a continuous type kneader, so that an agglutinate was obtained. The agglutinate thus obtained was subjected to vacuum devolatilization at 115° C. so that water was removed. Thereafter, analyses were carried out.

### Comparative Example 3

The temperature inside a 1 L mixing vessel was set to 30° C., and then 126 parts of methyl ethyl ketone (MEK) was introduced into the mixing vessel. Subsequently, while the MEK in the mixing vessel was stirred, 126 parts of the aqueous latex (L-1) containing the fine polymer particles (A) was introduced into the mixing vessel. Next, the materials thus introduced were mixed uniformly. Thereafter, while the materials were stirred, 200 parts of water (452 parts in total) was introduced into the mixing vessel at a feed rate of 80 parts/min. After the water was fed, stirring was promptly stopped, and slurry containing a buoyant agglutinate was obtained.

Next, 350 parts by mass of a liquid phase was let out from an outlet in a lower part of the mixing vessel so that the agglutinate remained in the mixing vessel. To the agglutinate (fine polymer particles (A) dope) thus obtained, 150 parts of MEK was added. The agglutinate and the MEK were mixed. As a result, an organic solvent solution in which the fine polymer particles (A) were dispersed was obtained. To 277 parts of this organic solvent solution (including 42.9 parts of the fine polymer particles (A)), 100 parts of a liquid epoxy resin was introduced. The materials thus blended were mixed, and then the MEK was distilled off from a resulting mixture under reduced pressure, As a result, a resin composition was obtained. Analyses were carried out with respect to the resin composition thus obtained.

### Comparative Example 4

To 333 g of the aqueous latex (L-1), 150 g of a liquid epoxy resin was added. A mixture thus obtained was subjected to vacuum devolatilization at 115° C. so that water was removed. Analyses were carried out with respect to a resin composition thus obtained.

### Comparative Example 5

To 150 g of a liquid epoxy resin, 20 g of 24% sodium sulfate was added. These materials were mixed with use of a spatula. Next, to a resulting mixture, 333 g of the aqueous latex (L-1) was added. These materials were mixed with use of a spatula, so that an agglutinate containing the fine polymer particles (A) and the resin (B) was obtained. The latex was then separated into the agglutinate and a water component. Mixed were 200 g of the agglutinate thus obtained and 300 g of ion exchanged water. A resulting mixture was stirred at 90° C. for 30 minutes. Next, the mixture thus obtained was subjected to oil-water separation, and the agglutinate was taken out. The agglutinate thus obtained was subjected to vacuum devolatilization at 115° C. so that water was removed. Thereafter, analyses were carried out.

### Comparative Example 6

Instead of 24% sodium sulfate, 20 g of 24% sodium chloride was used. Operations similar to those in Comparative Example 5 were carried out, except for the above point.

### Comparative Example 7

Operations similar to those in Comparative Example 5 were carried out, except that 333 g of the aqueous latex (L-2) was used instead of the aqueous latex (L-1).

### Comparative Example 8

Operations similar to those in Comparative Example 5 were carried out, except that 333 g of the aqueous latex (L-3) was used instead of the aqueous latex (L-1).

Table 1 shows results of analyses.

TABLE 1

| | | Organic | | | | | | | | | Electric |
|---|---|---|---|---|---|---|---|---|---|---|---|
| | Dispersibility | solvent | S | P | Ca | Mg | Al | Fe | Zn | Ba | conductivity |
| | μm | ppm | ppm | ppm | ppm | ppm | ppm | ppm | ppm | ppm | mS/cm |
| Example 1 | 0 | 0 | 60 | 2 | 3 | 39 | 12 | 9 | 1 | 14 | 0.50 |
| Example 2 | 0 | 0 | 66 | 2 | 1 | 40 | 12 | 11 | 1 | 11 | 0.12 |
| Example 3 | 0 | 0 | 1 | 62 | 1 | 37 | 11 | 10 | 1 | 14 | 0.15 |
| Example 4 | 0 | 0 | 40 | 2 | 1 | 40 | 11 | 11 | 2 | 14 | 0.10 |
| Example 5 | 0 | 0 | 41 | 2 | 1 | 39 | 11 | 13 | 1 | 15 | 0.06 |
| Example 6 | 0 | 0 | 61 | 2 | 1 | 37 | 11 | 9 | 0 | 16 | 0.10 |
| Example 7 | 0 | 0 | 114 | 2 | 1 | 41 | 12 | 13 | 0 | 18 | 0.20 |
| Comparative | 40 | — | — | — | — | — | — | — | — | — | — |
| Example 1 | | | | | | | | | | | |
| Comparative | 20 | — | — | — | — | — | — | — | — | -— | — |
| Example 2 | | | | | | | | | | | |
| Comparative | 0 | 3500 | — | — | — | — | — | — | — | — | — |
| Example 3 | | | | | | | | | | | |
| Comparative | 0 | 0 | 310 | 6 | 10 | 40 | 12 | 12 | 0 | 16 | — |
| Example 4 | | | | | | | | | | | |
| Comparative | 0 | 0 | 375 | 2 | 10 | 40 | 11 | 10 | 0 | 14 | 1.19 |
| Example 5 | | | | | | | | | | | |
| Comparative | 0 | 0 | 70 | 2 | 10 | 42 | 12 | 12 | 0 | 11 | 0.89 |
| Example 6 | | | | | | | | | | | |
| Comparative | 0 | 0 | 613 | 83 | 1 | 42 | 13 | 9 | 1 | 15 | 2.60 |
| Example 7 | | | | | | | | | | | |
| Comparative | 0 | 0 | 1507 | 2 | 1 | 42 | 12 | 13 | 0 | 13 | 3.20 |
| Example 8 | | | | | | | | | | | |

According to one or more embodiments of the present invention, it is possible to blend a resin composition with a thermosetting resin and suitably use a resulting mixture in various applications such as adhesive agents and coating materials.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A method of producing a resin composition, comprising:
a rapid freezing step of rapidly freezing a latex containing fine polymer particles (A);
a thawing step of thawing the latex which has been frozen in the rapid freezing step;
a resin mixing step of mixing, into the latex which has been subjected to the rapid freezing step, a resin (B) which is, at 25° C., a liquid having a viscosity of 100 mPa·s to 1,000,000 mPa·s, a semisolid, or a solid; and
after the thawing step and the resin mixing step, a separating step of separating the latex into the resin composition and a water component, the resin composition being an agglutinate containing the fine polymer particles (A) and the resin (B);
wherein the fine polymer particles (A) having at least a graft part which is constituted by a polymer containing, as one or more structural units that derived from at least one type of monomer selected from the group consisting of aromatic vinyl monomers, vinyl cyanide monomers, and (meth)acrylate monomers; and
in a case where a total amount of the fine polymer particles (A) and the resin (B) is regarded as 100% by weight, an amount of the fine polymer particles (A) be 1% by weight to 70% by weight and an amount of the resin (B) be 30% by weight to 99% by weight.

2. A method of producing a resin composition, comprising:
a resin mixing step of mixing, into a latex containing fine polymer particles (A), a resin (B) which is, at 25° C., a liquid having a viscosity of 100 mPa·s to 1,000,000 mPa·s, a semisolid, or a solid;
a shearing step of applying shearing stress to the latex which has been obtained in the resin mixing step; and
after the shearing step, a first separating step of separating the latex into a resin composition and a water component, the resin composition being an agglutinate containing the fine polymer particles (A) and the resin (B);
wherein the fine polymer particles (A) having at least a graft part which is constituted by a polymer containing, as one or more structural units that derived from at least one type of monomer selected from the group consisting of aromatic vinyl monomers, vinyl cyanide monomers, and (meth)acrylate monomers; and
in a case where a total amount of the fine polymer particles (A) and the resin (B) is regarded as 100% by weight, an amount of the fine polymer particles (A) be 1% by weight to 70% by weight and an amount of the resin (B) be 30% by weight to 99% by weight.

3. The method as set forth in claim 2, further comprising:
an agglutinating step of agglutinating the fine polymer particles (A) and the resin (B) contained in the water component from which the agglutinate has been separated in the first separating step, so as to obtain the resin composition which is the agglutinate containing the fine polymer particles (A) and the resin (B); and
after the agglutinating step, a second separating step of separating the resin composition, which is the agglutinate containing the fine polymer particles (A) and the resin (B), and the water component.

4. The method as set forth in claim 3, wherein the agglutinating step includes a step of freezing the water component from which the agglutinate has been separated in the first separating step.

5. The method as set forth in claim 1, wherein the separating step, a first separating step, or a second separating step includes a step of adjusting a water content of the agglutinate to 5% by weight to 60% by weight with respect to 100% by weight of the agglutinate.

6. The method as set forth in claim 1, further comprising a washing step of washing the resin composition.

7. A resin composition comprising:
fine polymer particles (A) which have a graft part that is constituted by a polymer containing, as one or more structural units, the one or more structural units derived from at least one type of monomer selected from the group consisting of aromatic vinyl monomers, vinyl cyanide monomers, and (meth)acrylate monomers; and
a resin (B) which is, at 25° C., a liquid having a viscosity of 100 mPa·s to 1,000,000 mPa·s, a semisolid, or a solid,
in a case where a total amount of the fine polymer particles (A) and the resin (B) is regarded as 100% by weight, an amount of the fine polymer particles (A) being 1% by weight to 70% by weight and an amount of the resin (B) being 30% by weight to 99% by weight,
in a case where an amount of the fine polymer particles (A) contained in the resin (B) is 5% by weight, dispersibility of the fine polymer particles (A) in the resin (B) being not more than 0 μm when evaluated in accordance with JIS K5101 with use of a grind gauge,
the resin composition substantially not containing an organic solvent,
the resin composition containing sulfur (S) and phosphorus (P) each in an amount of not more than 150 ppm,
the resin composition having an electric conductivity of not more than 0.6 mS/cm; and
the resin (B) is selected from the group consisting of: epoxy resins; phenolic resins; polyol resins; and amino-formaldehyde resins (melamine resins).

8. The resin composition as set forth in claim 7, wherein the resin composition contains calcium (Ca), magnesium (Mg), iron (Fe), zinc (Zn), barium (Ba), and aluminum (Al) each in an amount of not more than 100 ppm.

9. The resin composition as set forth in claim 7, wherein the fine polymer particles (A) are constituted by a rubber-containing graft copolymer which has an elastic body and the graft part grafted to the elastic body.

10. The resin composition as set forth in claim 9, wherein the elastic body includes at least one type of elastic body selected from the group consisting of diene-based rubbers, (meth)acrylate-based rubbers, and polysiloxane rubber-based elastic bodies.

11. The resin composition as set forth in claim 7, wherein the resin (B) includes a thermosetting resin.
